(19) United States
(12) Patent Application Publication
(10) Pub. No.: US 2015/0332325 A1
(43) Pub. Date: Nov. 19, 2015

(54) System and Method for Visualizing Real-Time Location-Based Events

(71) Applicant: xAd, Inc., New York, NY (US)

(72) Inventors: Dipanshu Sharma, Las Vegas, NV (US); Stephen Anderson, Cupertino, CA (US); Nishant Khatri, Santa Clara, CA (US); Jonathan Schwartz, San Francisco, CA (US); David Chock, Saratoga, CA (US)

(21) Appl. No.: 14/716,813

(22) Filed: May 19, 2015

Related U.S. Application Data
(60) Provisional application No. 62/000,494, filed on May 19, 2014.
(60) Provisional application No. 62/000,496, filed on May 19, 2014.
(60) Provisional application No. 62/000,497, filed on May 19, 2014.
(60) Provisional application No. 62/000,499, filed on May 19, 2014.
(60) Provisional application No. 62/000,501, filed on May 19, 2014.
(60) Provisional application No. 62/066,912, filed on Oct. 22, 2014.
(60) Provisional application No. 62/067,965, filed on Oct. 23, 2014.
(60) Provisional application No. 62/119,807, filed on Feb. 24, 2015.

(51) Int. Cl. G06Q 30/02; H04W 4/02

(52) U.S. Cl. CPC G06Q 30/0259; H04W 4/021; G06Q 30/0267

(57) ABSTRACT

A map-based system and method allow an operator of a computer system to visualize real-time events of mobile users entering, staying within, and exiting geographic regions of interest. The method comprises receiving a first request for document from the packet-based network, the first request including a first plurality of parameters associated with a first mobile device, and determining whether the first plurality of parameters indicate a first real-time location-based event of the mobile device being in proximity of a geographic location of a first business. In response to the first real-time location-based event being determined, the method updates aggregated historical/statistical data including increasing one or more counts of location-based events associated with the first business over one or more periods of time, and transmit information associated with the first real-time location-based event to one or more second computer systems in the packet-based network, the information enabling the one or more second computer systems to visualize the first real-time location-based event together with other real-time location-based events on one or more display devices.

### CROSS REFERENCE TO RELATED APPLICATIONS

The present present application claims the benefit of priority to U.S. Provisional Patent Application No. 62/000,494, filed May 19, 2014, entitled “Method and Apparatus for Visualizing Real-Time Location-Based Events,” U.S. Provisional Patent Application No. 62/000,496, filed May 19, 2014, entitled “Method and Apparatus for Retargeting Mobile Users Based on Store Visits,” U.S. Provisional Patent Application No. 62/000,497, filed May 19, 2014, entitled “Method and Apparatus for Increasing Store Visitation Responses to Location-Based Mobile Advertising,” U.S. Provisional Patent Application No. 62/000,499, filed May 19, 2014, entitled “Method and Apparatus for Modeling and Using Mobile User Intent Profile in Location-Based Mobile Advertising,” U.S. Provisional Patent Application No. 62/000,501, filed May 19, 2014, entitled “Method and Apparatus for Deriving and Using IP regions in Location-Based Mobile Advertising,” U.S. Provisional Patent Application No. 62/066,912, filed Oct. 22, 2014, entitled “Method and Apparatus for Geo-Fencing Using Map Overlay,” U.S. Provisional Patent Application No. 62/067,965, filed Oct. 23, 2014, entitled “Method and Apparatus for Mobile Advertising Using 3D Geo-Fencing,” U.S. Provisional Patent Application No. 62/119,807, filed Feb. 24, 2015, entitled “Methods and Apparatus for Marketing Mobile Advertising Supplies,” each of which is incorporated herein by reference in its entirety. The present application is related to co-pending U.S. patent application Ser. No. 13/867,025, filed Apr. 19, 2013, U.S. patent application Ser. No. 13/867,029, filed Apr. 19, 2013, U.S. patent application entitled “System and Method for Marketing Mobile Advertising Supplies,” filed on even date herewith, U.S. patent application entitled “System and Method for Visualizing Real-Time Location-Based Events,” filed on even date herewith, and U.S. patent application entitled “System and Method for Estimating Mobile Device Locations,” filed on even date herewith, each of which is incorporated herein by reference in its entirety.

### FIELD

The present disclosure is related to mobile advertising, and more particularly to methods and apparatus for marketing location-based supplies in mobile advertising.

### DESCRIPTION OF THE RELATED ART

Hyperlocal advertising is the ability to deliver precise, relevant, and timely advertising to consumers based on estimates of their locations at the moments of delivery. Nowadays, with the advent of smartphones and tablets, hyperlocal advertising is becoming increasingly popular among online marketers as a vehicle of choice to deliver their messages to targeted mobile audiences on mobile devices. Various industry experts predict over 1.5 trillion mobile consumer page views a month, translating to hundreds of billions of ad impression opportunities a month, or billions a day. There are currently an estimated 20 million stores and small businesses located in the US alone that can benefit from hyperlocal advertising.

Geo-Fencing or location-based targeting involves sending information or push notifications to consumers who enter virtual perimeters set around physical places. Such technologies allow an advertiser to create a virtual “fence” around a point or place of interests. For example, an advertiser can pinpoint a store, and deliver a specific advertisement (“ad”) to anyone who comes within a pre-defined geographic area around that store. Ads delivered through geo-fencing typically yield higher response rate and better return of investment for advertisers since they're more contextual. Therefore, it is desirable for mobile advertisers to have knowledge about the locations of mobile users with respect to businesses of interests.

### BRIEF DESCRIPTION OF THE DRAWINGS

FIG. 1 is a diagrammatic representation of a packet-based network according to embodiments.

FIG. 2 is a diagrammatic representation of a computer/server that performs one or more of the methodologies and/or to provide one or more of the systems in an advertisement platform according to embodiments.

FIG. 3 is a diagrammatic representation of a geo-fence definition system according to certain embodiments.

FIG. 4A is a diagrammatic representation a simple geo-fence in the shape of a circle.

FIG. 4B is a diagrammatic representation of one or more polygon geo-fences defined in conformity with geographical configuration and surroundings of a store according to certain embodiments.

FIG. 4C is a table illustrating examples of geo-fences stored in a geo-fence database according to certain embodiments.

FIG. 5A is a diagrammatic representation of a polygon gen-fence that overlaps with major roads according to certain embodiments.

FIG. 5B is a diagrammatic representation of a virtual rectangle created to contain the geo-fence in FIG. 5A according to certain embodiments.

FIG. 5C is a diagram showing parts of major roads overlapping with the virtual rectangle being translated into line segments, according to certain embodiments.

FIG. 5D is a diagrammatic representation of an enhanced geo-fence including a circle drawn around a business and line segments drawn along edges and center dividers of major roads overlapping with the circle, according to certain embodiments.

FIG. 6A is a diagrammatic representation different kinds of businesses stacked on top of each other in a high-rise building complex.

FIG. 6B is a diagrammatic representation of 2-D polygon geo-fences triggered by a mobile user location on the 10^{th} floor of a high-rise complex according to certain embodiments.

FIG. 6C is a diagrammatic representation of 3-D enhanced geo-fences that mirror single-floor, multi-floor, and/or above-air spaces or volumes, respectively, in or around a high-rise building complex according to certain embodiments.

FIG. 6D is a diagrammatic representation of a virtual tube geo-fence stretching along part of or the entire length of a flight path of a commercial flight according to certain embodiments.

FIG. 7 is a diagrammatic representation of a request processing system that processes mobile ad requests received from a network according to certain embodiments.

FIG. 8A is a flowchart illustrating a method performed by the request processing system according to certain embodiments.

FIG. 8B is a flowchart illustrating a location process to generate location data according to certain embodiments.

FIG. 8C is a flowchart illustrating a geo-fencing process to determine whether the location data triggers one or more predefined places in a geo-fence database according to certain embodiments.

FIG. 8D is a flowchart illustrating a process for determining whether any of the triggered geo-fences should be excluded or discarded according to certain embodiments.

FIGS. 9A-9C are block diagrams illustrating some of the content of an ad request at different stages of processing by the request processing system according to certain embodiments.

FIG. 10A is a diagrammatic representation of a real-time ad event visualization system according to certain embodiments.

FIG. 10B is a flow diagram of the real-time ad event visualization system interracting with other systems/services either locally or across a network according to certain embodiments.

FIG. 11 is diagrammatic representation of a mobile user in an overlapped area of two geo-fences and for two different businesses according to certain embodiments.

FIG. 12 is a table illustrating a few examples of real-time location-based events stored in a digital storage according to certain embodiments.

FIGS. 13A-13D are diagrammatic representations of real-time location-based events being displayed on a display device.

FIG. 14 is a diagrammatic representation of an IP region system provided by a computer/server system according to certain embodiments.

FIG. 15 is a flowchart illustrating a method performed by the IP region system to derive IP regions for respective IP addresses according to certain embodiments.

FIG. 16 is a diagram illustrating an exemplary IP region created using location information from multiple ad requests according to certain embodiments.

FIG. 17 is a diagram illustrating an exemplary IP region for a large establishment such as an airport according to certain embodiments.

FIG. 18 illustrates a few examples of IP regions stored in the database as spatial indices together with the associated IP addresses and other information such as their respective centroids, etc. according to certain embodiments.

### DESCRIPTION OF THE EMBODIMENTS

The present disclosure provides a mobile advertising platform in which mobile user locations and other information are translated into indications of mobile user intent to approach certain businesses, and advertisers can fill mobile advertising requests or choose to price their bids for mobile supplies based on such indications. In certain embodiments, pre-defined places associated with business/brand names are created, and mobile advertising requests are processed to determine if the associated with mobile devices have triggered any of these pre-defined places. If a mobile advertising request is determined to have triggered one or more of the pre-defined places, it is regarded as a real-time location based event and is visualized together with other real-time location based events and statistical data on a display device.

In certain embodiments, a first computer system coupled to a packet-based network performs a visualization method for visualizing real-time location based events. The packet-based network includes one or more second computer systems. The method comprises receiving a first ad request from the packet-based network, the first ad request being associated with a mobile device, estimating a first location of the mobile device based on information in the ad request, querying a geo-fence database in a storage device with the estimated first location, in response to the first location triggering a first geo-fence in the geo-fence database, updating aggregated historical/statistical data for a first business associated with the first geo-fence; and transmitting information associated with the first geo-fence to the one or more second computer systems in the packet-based network, the information enabling the one or more second computer systems to visualize the triggering of the first geo-fence by the estimated mobile device location.

In certain embodiments, updating aggregated data for the first geo-fence comprises increasing one or more of a number of visits made to the first business by mobile users during a predefined period of time, a number of times a geo-fence associated with a brand of the first business has been triggered during the predefined period of time, and a number of times a geo-fence associated with a category of the first business has been triggered during the predefined period of time.

In certain embodiments, the visualization method further comprises transmitting the aggregated data to the one or more second computer systems in response to a request from the one or more second computer systems.

In certain embodiments, the first business is related to a second business, and the visualization method further comprises updating affinity data for the second business based on updated aggregated historical/statistical data for the first business.

In certain embodiments, the visualization method further comprises receiving a second ad request from the packet-based network, the second ad request being associated with the mobile device; estimating a second location of the mobile device based on information in the second ad request; querying the geo-fence database in the storage device with the second location; and in response to the second location triggering a second geo-fence in the geo-fence database and the second geo-fence being different from the first geo-fence, updating a number of mobile users remaining in the first business.

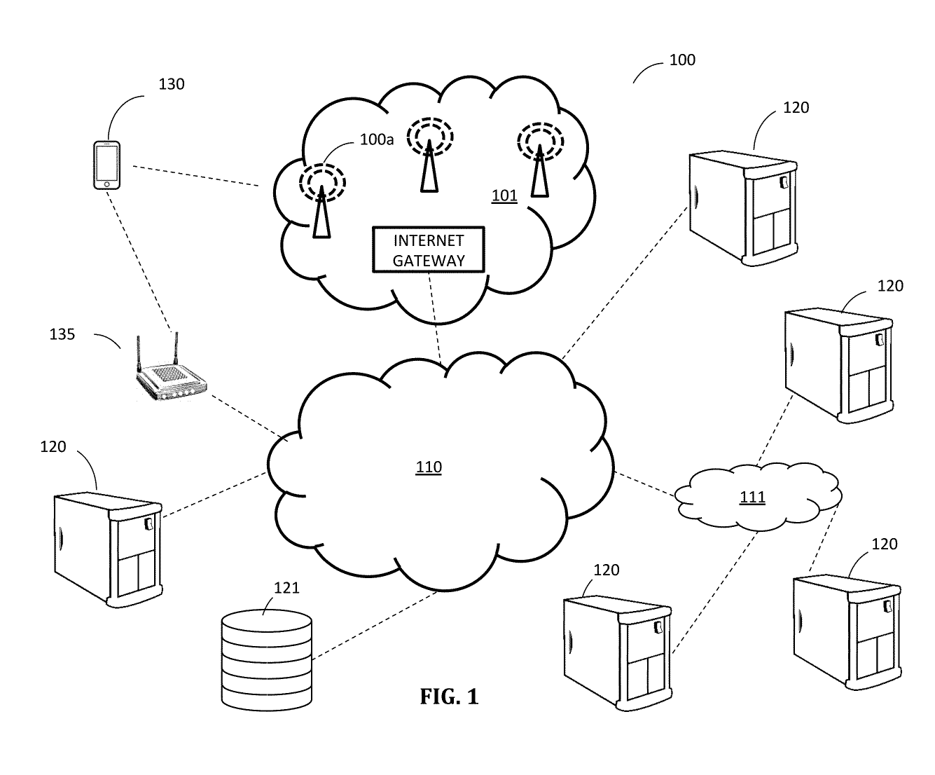

FIG. 1 illustrates a packet-based network 100 (referred sometimes herein as “the cloud”), which, in some embodiments, includes part or all of a cellular network 101, the Internet 110, and computers/servers 120, coupled to the Internet (or web) 110. The computers/servers 120 can be coupled to the Internet 110 using wired Ethernet and optionally Power over Ethernet (PoE), WiFi, and/or cellular connections via the celular network 101 including a plurality of celular towers 101a. The network may also include one or more network attached storage (NAS) systems 121, which are computer data storage servers connected to a computer network to provide data access to a heterogeneous group of clients. As shown in FIG. 1, one or more mobile devices 130 such as smart phones or tablet computers are also coupled to the packet-based network via cellular connections to the cellular network 101, which is coupled to the Internet 110 via an Internet Gateway. When a WiFi hotspot (such as hotspot 135) is available, a mobile device 130 may connect to the Internet 110 via a WiFi hotspot 135 using its built-in WiFi connection. Thus, the mobile devices 130 may interact with other computers/servers coupled to the Internet 110.

The computers/servers 120 coupled to the Internet may include one or more publishers that interact with mobile devices running apps provided by the publishers, one or more ad middlemen or ad networks that act as intermediaries between publishers and advertisers, one or more ad servers that select and send advertisement documents to the publishers to post on mobile devices, one or more computers/servers running ad exchanges, one or more computers/servers that post mobile supplies on the ad exchanges, and/or one or more advertisers that monitor the ad exchanges and place bids for the mobile supplies posted in the ad exchanges. The publishers, as they interact with the mobile devices, generate the mobile supplies, which can be requests for advertisements (ad requests) carrying characteristics of the mobile devices, certain information about their users, and raw location data associated with the mobile devices, etc. The publishers may post the mobile supplies on the ad exchanges for bidding by the advertisers or their agents, transmit the mobile supplies to an ad agent or ad middleman for fulfillment, or fulfill the supplies themselves.

Advertisers, agencies, publishers and ad middlemen can also purchase mobile supplies through ad exchanges. Ad networks and other entities also buy ads from exchanges. Ad networks typically aggregate inventory from a range of publishers, and sell it to advertisers for a profit. An ad exchange is a digital marketplace that enables advertisers and publishers to buy and sell advertising space (impressions) and mobile ad inventory. The price of the impressions can be determined by real-time auction, through a process known as real-time bidding. That means there's no need for human salespeople to negotiate prices with buyers, because impressions are simply auctioned off to the highest bidder. These processes take place in milliseconds, as a mobile device loads an app or webpage.

Advertisers and agencies can use demand-side platforms (DSP), which are softwares that use certain algorithms to decide whether to purchase a certain supply. Many ad networks now also offer some sort of DSP-like product or real-time bidding capability. As on-line and mobile publishers are making more of their inventory available through exchanges, it becomes more cost efficient for many advertisers to purchase ads using DSPs.

An ad server is a computer server, e.g., a web server, backed by a database server, that stores advertisements used in online marketing and place them on web sites and/or mobile applications. The content of the webserver is constantly updated so that the website or webpage on which the ads are displayed contains new advertisements—e.g., banners (static images/animations) or text—when the site or page is visited or refreshed by a user. In addition to selecting and delivering ads to users, the ad servers also manage website advertising space and/or to provide an independent counting and tracking system for advertisers. Thus, the ad servers provide/serve ads, count them, choose ads that will make the websites or advertisers most money, and monitor progress of different advertising campaigns. Ad servers can be publisher ad servers, advertiser ad servers, and/or ad middleman ad servers. An ad server can be part of the same computer or server that also act as a publisher, advertiser, and ad middleman.

Ad serving may also involve various other tasks like counting the number of impressions/clicks for an ad campaign and generating reports, which helps in determining the return on investment (ROI) for an advertiser on a particular website. Ad servers can be run locally or remotely. Local ad servers are typically run by a single publisher and serve ads to that publisher's domains, allowing fine-grained creative, formatting, and content control by that publisher. Remote ad servers can serve ads across domains owned by multiple publishers. They deliver the ads from one central source so that advertisers and publishers can track the distribution of their online advertisements, and have one location for controlling the rotation and distribution of their advertisements across the web.

The computer/servers 120 can include server computers, client computers, personal computers (PC), tablet PC, set-top boxes (STB), personal digital assistant devices (PDA), web appliances, network routers, switches or bridges, or any computing devices capable of executing instructions that specify actions to be taken by the computing devices. As shown in FIG. 1, some of the computers/servers 120 are coupled to each other via a local area network (LAN) 110, which in turn is coupled to the Internet 110. Also, each computer/server 120 referred herein can include any collection of computing devices that individually or jointly execute instructions to provide one or more of the systems discussed herein, or to perform any one or more of the methodologies or functions discussed herein, or to act individually or jointly as one or more of a publisher, an advertiser, an advertisement agency, an ad middleman, an ad server, an ad exchange, etc, which employs the systems, methodologies, and functions discussed herein.

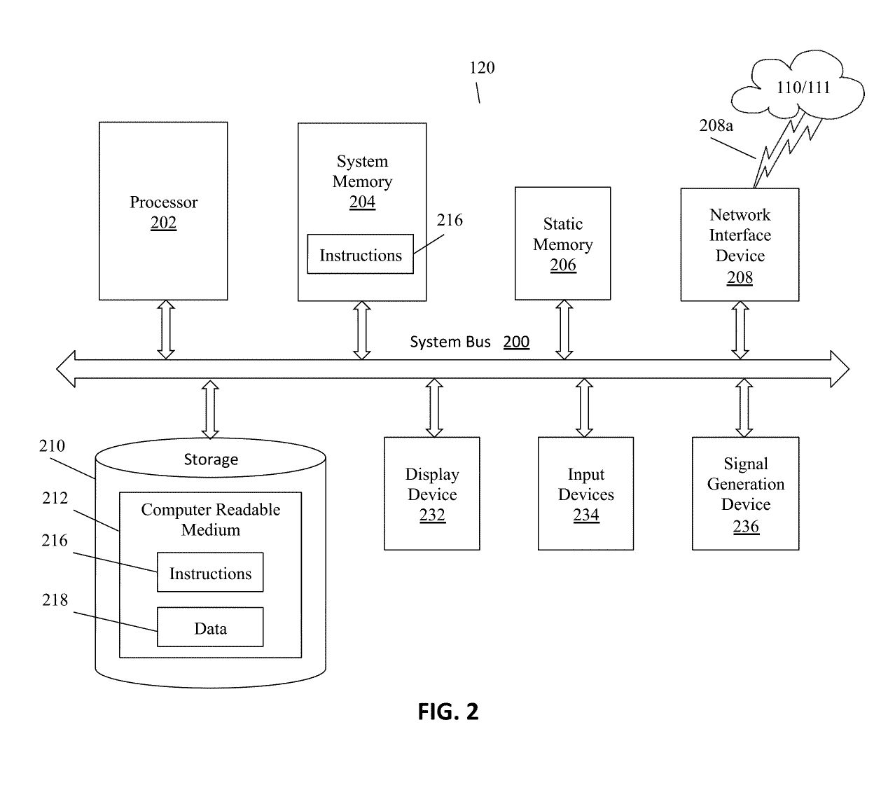

FIG. 2 illustrates a diagrammatic representation of a computer/server 120 that can be used to perform one or more of the methodologies and/or to provide one or more of the systems in an advertisement platform discussed herein, by executing certain instructions. The computer/server 120 may operate as a standalone device or as a peer computing device in a peer-to-peer (or distributed) network computing environment. As shown in FIG. 2, the computer/server 120 includes one or more processors 202 (e.g., a central processing unit (CPU), a graphic processing unit (GPU), and/or a digital signal processor (DSP)) and a system or main memory 204 coupled to each other via a system bus 200. The computer/server 120 may further include static memory 206, a network interface device 208, a storage unit 210, one or more display devices 230, one or more input devices 234, and a signal generation device (e.g., a speaker) 236, with which the processor(s) 202 can communicate via the system bus 200.

In certain embodiments, the display device(s) 230 include one or more graphics display units (e.g., a plasma display panel (PDP), a liquid crystal display (LCD), a projector, or a cathode ray tube (CRT)). The input device(s) 234 may include an alphanumeric input device (e.g., a keyboard), a cursor control device (e.g., a mouse, trackball, joystick, motion sensor, or other pointing instrument). The storage unit 210 includes a machine-readable medium 212 on which is stored instructions 216 (e.g., software) that enable anyone or more of the systems, methodologies or functions described herein. The storage unit 210 may also store data 218 used and/or generated by the systems, methodologies or functions. The instructions 216 (e.g., software) may be loaded, completely or partially, within the main memory 204 or within the processor 202 (e.g., within a processor's cache memory) during execution thereof by the computer/server 120. Thus, the main memory 204 and the processor 1102 also constituting machine-readable media.

While machine-readable medium 212 is shown in an example implementation to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., instructions 216) for execution by the computer/server 120 and that cause the computing device 1100 to perform anyone or more of the methodologies disclosed herein. The term “machine-readable medium” includes, but not be limited to, data repositories in the form of solid-state memories, optical media, and magnetic media. In certain embodiments, the instructions 216 and/or data 218 can be stored in the network 100 and accessed by the computer/server 120 via its network interface device 208, which provides wired and/or wireless connections to a network, such as a local area network 111 and/or a wide area network (e.g., the Internet 110) via some type of network connectors 280a. The instructions 216 (e.g., software) and or data 218 may be transmitted or received via the network interface device 208.

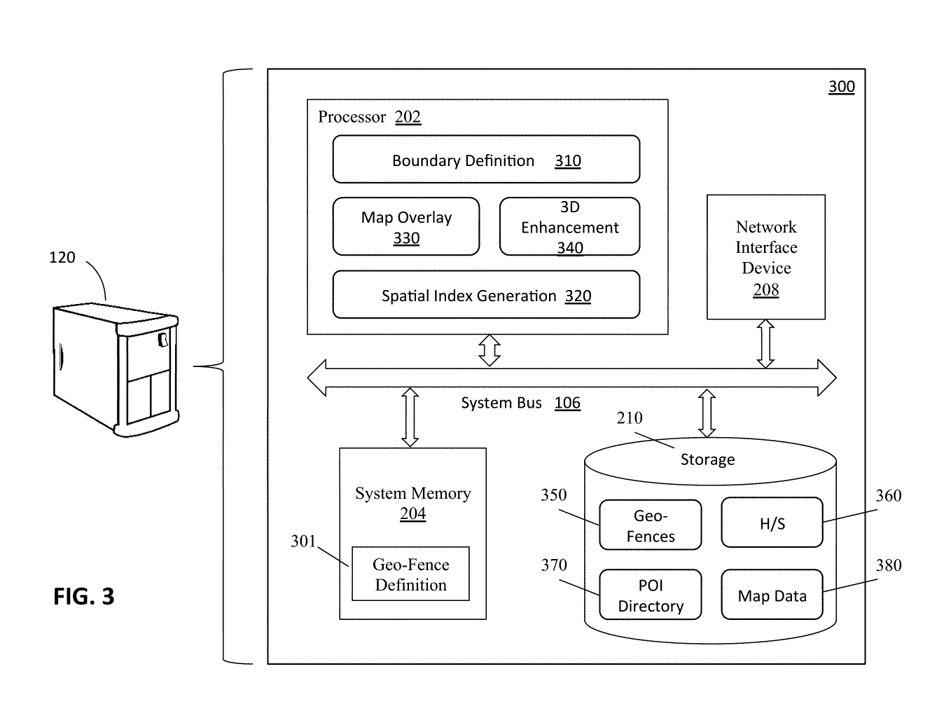

FIG. 3 is a diagrammatic representation of a geo-fence definition system 300 provided by a computer/server system 120 according to certain embodiments. As shown in FIG. 3, the processor 202 in the computer/server system 120, when executing a geo-fence definition software program 301 loaded in the main memory 204, provides a geo-fence definition system including a boundary definition module 310 and a spatial index generation module 320. The system 300 makes use of a plurality databases storing data used and/or generated by the geo-fence definition system 300, including a database 350 for storing the gen-fences generated by the spatial index generation module 320, a database 360 for storing historical/statistical (H/S) data, a database 370 for storing a Point of Interest (POI) directory, and a database 380 for storing map data. Any or all of these databases can be located in the storage 210, or in another server/computer 120 and/or NAS 121 in the network 100, which the process 202 can access via the network interface device 208.

The boundary definition module defines virtual perimeters of defined areas that mirror real-world geographical areas for mobile advertising. A defined area according to certain embodiments can be a static circle around a business location, e.g. a fence obtained using offline index databases such as InfoUSA (wvvw.infousa.com), which provides a list of businesses and their locations, or areas specified by marketers using predefined boundaries, such as neighborhood boundaries, school attendance zones, or parcel boundaries, etc. The defined areas according to certain embodiments can also be dynamically computed and can have arbitrary shapes that change depending on the time of the day, day of the week, or other variables, as described in co-pending U.S. patent application Ser. No. 13/867,025, filed Apr. 19, 2013, entitled “Method and Apparatus for Dynamic Fencing,” which has been incorporated by reference herein.

In certain embodiments, the defined areas include places computed by the boundary definition module 310 using business meta-information and/or geographical information. As shown in FIG. 3, the boundary definition module 310 has access to the (POI) directory (e.g., InfoUSA), which provides a list of POIs and their corresponding brand names, addresses, and geographical locations. The boundary definition module 310 may also have access to the map data 380, which provides information about the surroundings of the POIs in the POI directory. The boundary definition module 310 generates one or more places in the form of, for examples, a set of geographic points defining the perimeters of the one or more places, for each POI of interests based on the POI information.

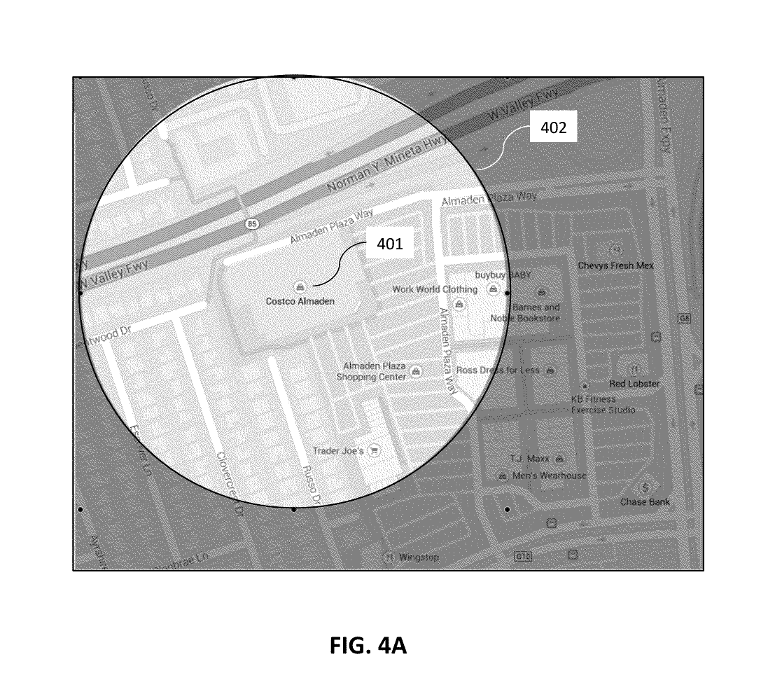

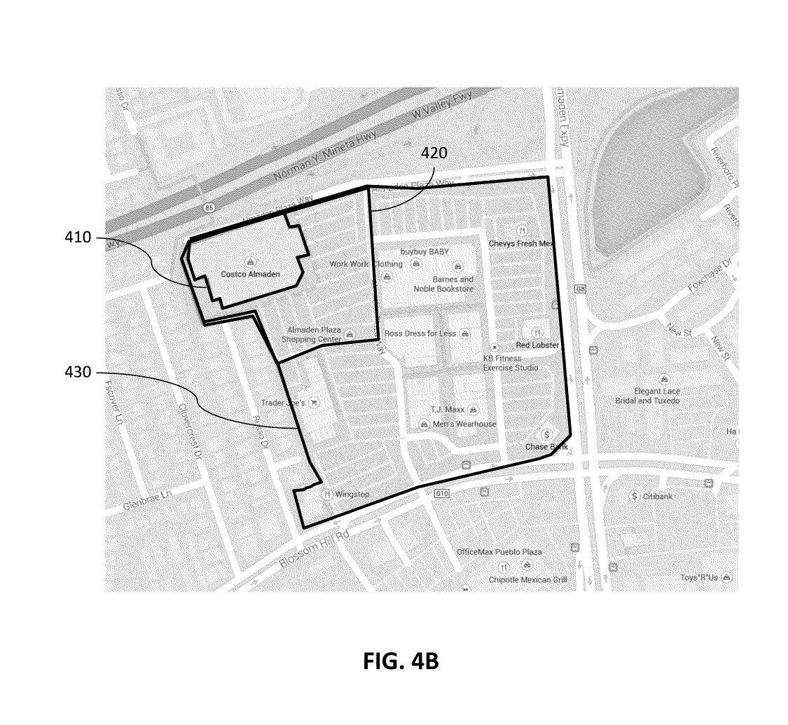

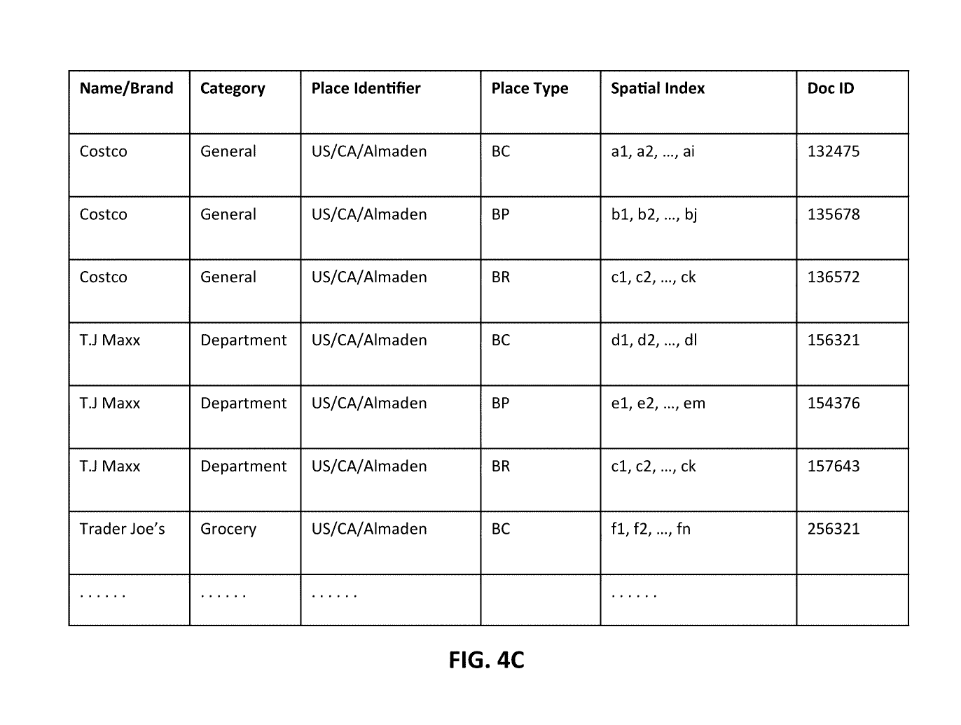

In certain embodiments, the boundary definition module 310 generates or defines one or more places for each of a plurality of POIs in consideration of the map data (e.g., Open Street Map) around the POI. For example, as shown in FIG. 4A, a simple geo-fence for the Costco Almaden store without consideration of the map data can be in the shape of a circle 402 around the store location 401, based on the assumption that a user's intent to visit a given POI could be derived from his or her distance from the POI. However, as shown in FIG. 4A, the circle fence encompasses a major highway, a residential area, and areas on the other side of the major highway. Ads served to mobile devices in these areas would most likely be ignored because people living close to the store, people traveling on the highway, and people on the other side of the highway are either already familiar with what the store has to offer or are unlikely to bother to respond to mobile ads related to the store.

Therefore, instead of geo-fences based on a radius around a centroid of a business location, the boundary definition module 310 according to certain embodiments uses the map data to define places that are of more interests to mobile advertisers. As shown in FIG. 4B, one or more polygons can be defined in conformity with the geographical configuration and surroundings of the store, such as a first polygon 410 around the building of the store, a second polygon 420 around the building and its parking lot, and/or a third polygon 430 around a shopping area or business region including the store and other stores.

In certain embodiments, different types of places may be defined for a POI so that mobile advertisers can offer different ads or different prices for ads delivered to mobile devices that have triggered these different types of places. For example, an ad request associated with a mobile device located inside the first polygon 410 around the building of the store may be more valuable to the store owner or a competing business and thus priced higher than an ad request associated with a mobile device that is in the shopping area (polygon 430) but not inside the store. Or, polygon 430 may be priced higher by the store owner to attract mobile users in the business region than polygon 410, which indicates that the mobile user is already in the store. In certain embodiments, these three types of places are defined by extracting building polygons, parking lot polygons and land-use polygons from local and national GIS systems. In certain embodiments, some or all of the places can be defined manually with assistance of computer annotation tools and by consulting some external map and/or satellite data to make sure that the geo-fences are aligned with the real building and region boundary information surrounding the intended businesses.

In certain embodiments, the different types of places associated with a business that are offered to the mobile advertisers include, for example, (1) a business center (BC) represented by, for example, a polygon corresponding to the perimeter of the building of the business (e.g., the first polygon 410 in FIG. 4B); (2) a business premise (BP) represented by a polygon corresponding to the perimeter of the business building and the neighboring parking lots (e.g., the second polygon 420 in FIG. 4B); and (3) a business region (BR) or area represented by a polygon corresponding to the perimeter of a shopping center or business or commercial area in which this business is located (e.g., the third polygon 430 in FIG. 4B). If a business center is triggered, it can be reliably inferred that the user is interested in the business by actually visiting it. Triggering of a business premise provides good indication of an intent to visit the business, but not as strong as triggering the business center. If a user triggers a business region, the intent may be regarded as valid but weaker than that from triggering a business premise.

The spatial index generation module 320 generates spatial indices representing the areas defined by the boundary definition module 310 to create geo-fences for storing in the geo-fence database 350, which is a spatial database that aids in the handling of spatial queries, such as how far two points differ, or whether certain point falls within a spatial area of interest. The spatial index generation module can employ conventional spatial indexing methods, and/or the indexing methods described in co-pending U.S. patent application Ser. No. 13/867,029, entitled “Method and Apparatus for Geographic Document Retrieval,” Filed Apr. 19, 2013, which has been incorporated herein by reference. FIG. 4C illustrates examples of geo-fences stored in the database 350, according to certain embodiments. As shown, the store Costco in Almaden has three different types of places associated with it—place US/CA/Almaden/BC is a business center (BC), which is a polygon around the store building and represented by spatial index a1, a2, . . . , ai; place US/CA/Almaden/BP is a polygon around the store's larger premise including its parking lot and represented by spatial index b1, b2, . . . , bj; and place US/CA/Almaden/BR is a polygon around the shopping center including the store and other stores and represented by spatial index c1, c2, . . . , ck. FIG. 4C also shows that the store T.J. Maxx has three types of places associated with it, and the store Trader Joe's has at least a business center place associated with it. As shown in FIG. 4C, each geo-fence entry in the database 350 includes the spatial indices associated with the respective place together with other information about the respective place, such as, for example, a name/brand associated with the place, a category of the place, a place identifier identifying a particular locale (e.g., city, district, etc.) for the place, the place type, and/or one or more doc IDs identifying one or more advertisement documents for the name/brand or the place.

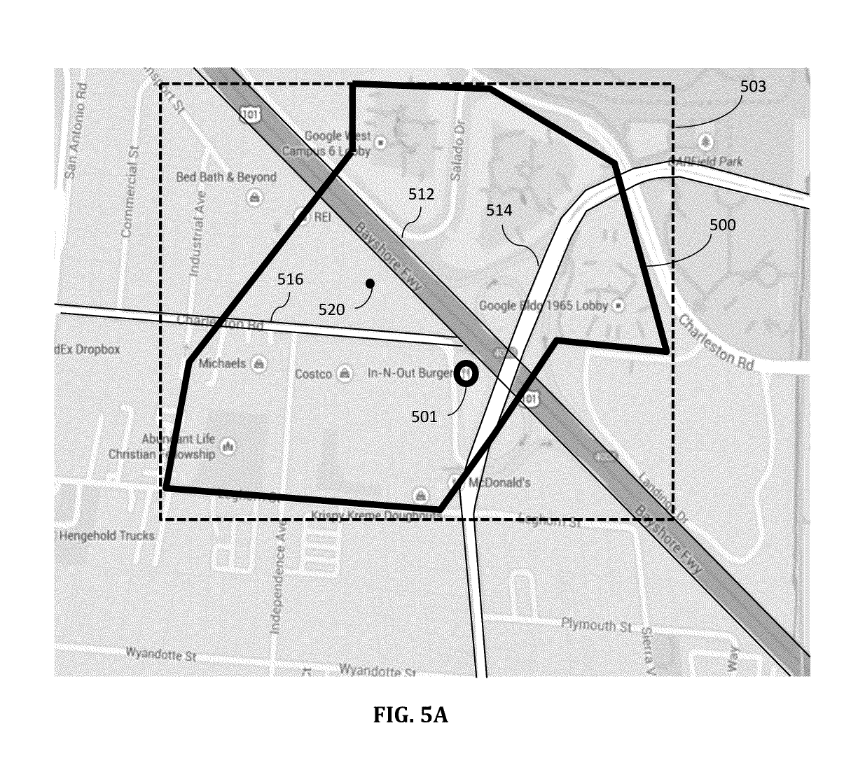

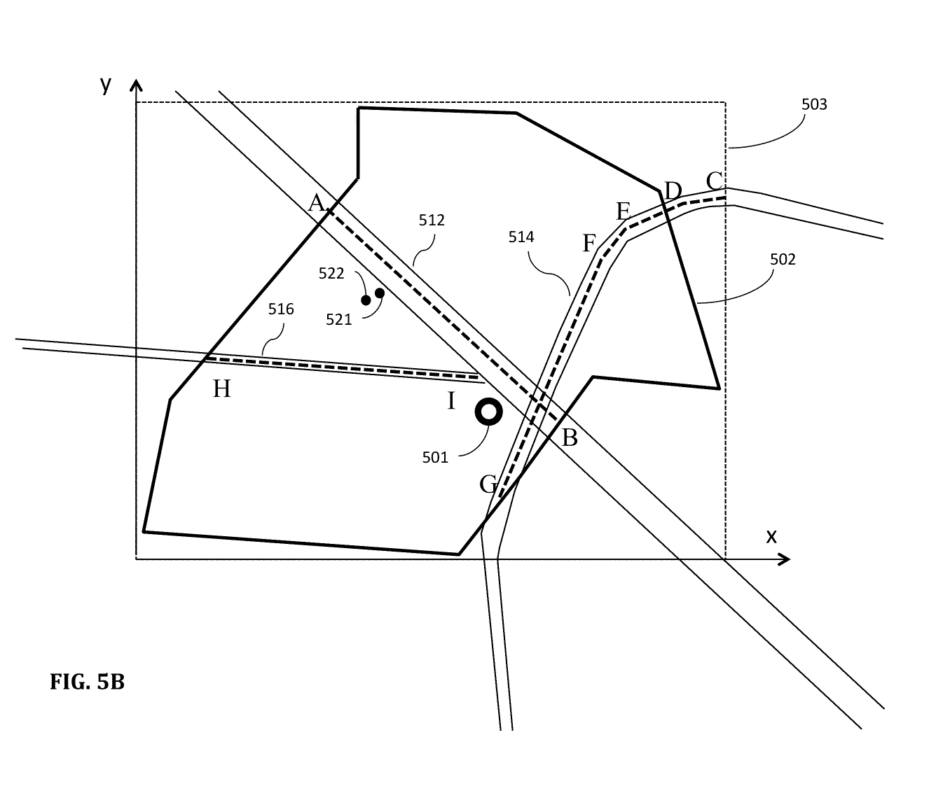

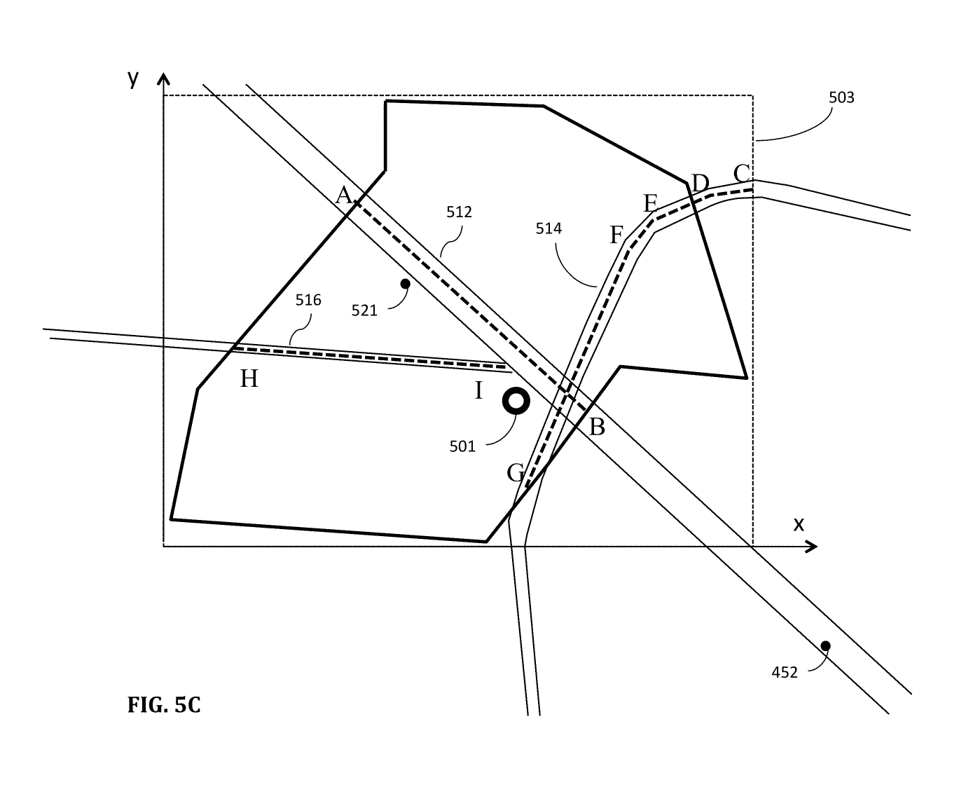

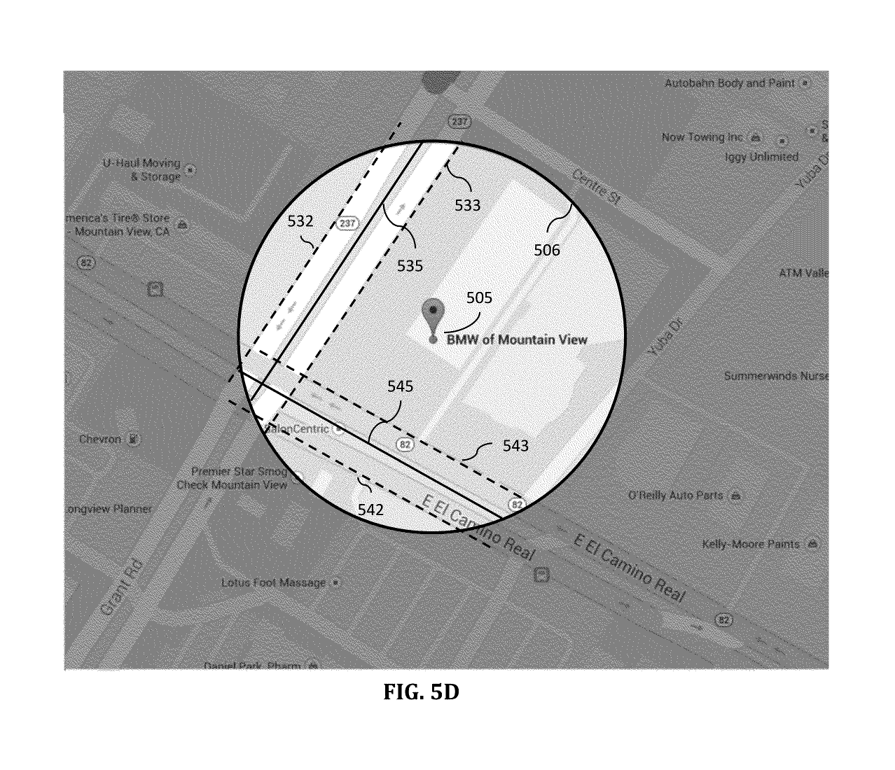

The geo-fence definition system 300 may further includes a map overlay module 330 that extracts map data for the major roads near a defined geo-fence and overlay the map data on top of the geo-fence to create an enhanced geo-fence. For example, as shown in FIG. 5A, the boundary definition module 310 generates a geo-fence 500 for a business 501, e.g., a restaurant. The geo-fence 500 in this example is a polygon encompassing the restaurant 501 and other businesses around the restaurant 501, because a mobile ad campaign for the business 501 is aimed at attracting mobile users visiting the other businesses or working in an office complex nearby. The ad campaign, however, desires to exclude mobile users traveling on major roads 512, 514 and 516 in the geo-fence 500. The rationale is that these mobile users could be traveling at high speeds and are less likely to respond to the mobile ads for the restaurant by circling back to the restaurant.

Thus, in certain embodiments, the map overlay module 330 creates a virtual rectangle 503 containing the geo-fence 500. The rectangle 503 can be the smallest rectangle containing the whole geo-fence 500, as shown in FIG. 5B. The map overlay module 310 then retrieves map data associated with major roads, e.g., roades 512, 514, and 516, that overlap with the virtual rectangle 503, and translates the map data into line segments. As shown in FIG. 5C, the parts of the major roads 512, 514, and 516 overlapping with the virtual rectangle 503 are translated into line segments AB, CD, DE, EF, FG, and HI. The geo-fence 500, together with the line segments, form an enhanced geo-fence for the restaurant 501, which can be used assess whether a mobile user associated with a ad request could be a traveler on one of the major roads.

Instead of, or in addition to, line segments drawn along or near the center divider of a major road, a major road can also be represented by a road band using by, for example, line segments drawn along opposite edges of the road. As shown in FIG. 5D, an enhanced geo-fence for a business 505 includes a circle 506 drawn around the business 505 and line segments 532, 533, 542, and 543. Line segments 532 and 533 are drawn along the edges of Hwy 237 on two opposite sides of the center divider 535 of Hwy 237, while line segment 542 and 543 are drawn along the edges of Hwy 82 on two opposite sides of the center divider 545 of Hwy 82. Thus, a mobile device located on a road band of a major road can be considered as traveling along the major road. Also, depending which side of a high way a mobile device is located, its distance from the high way can be measured from the edge of the highway on the same side.

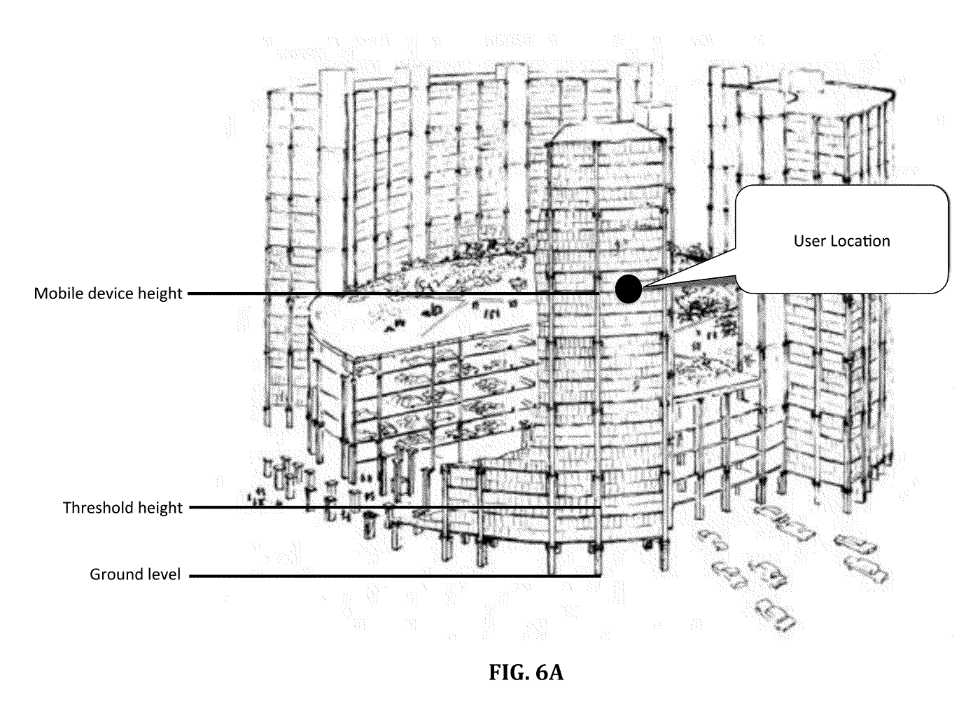

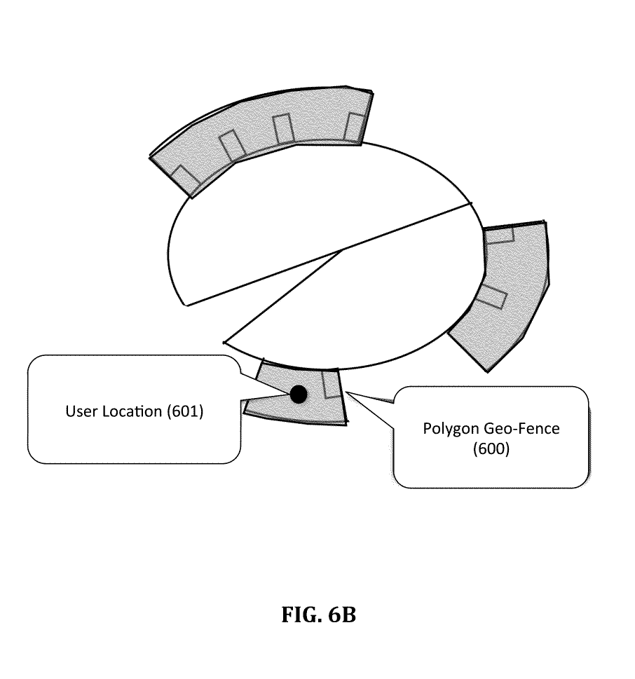

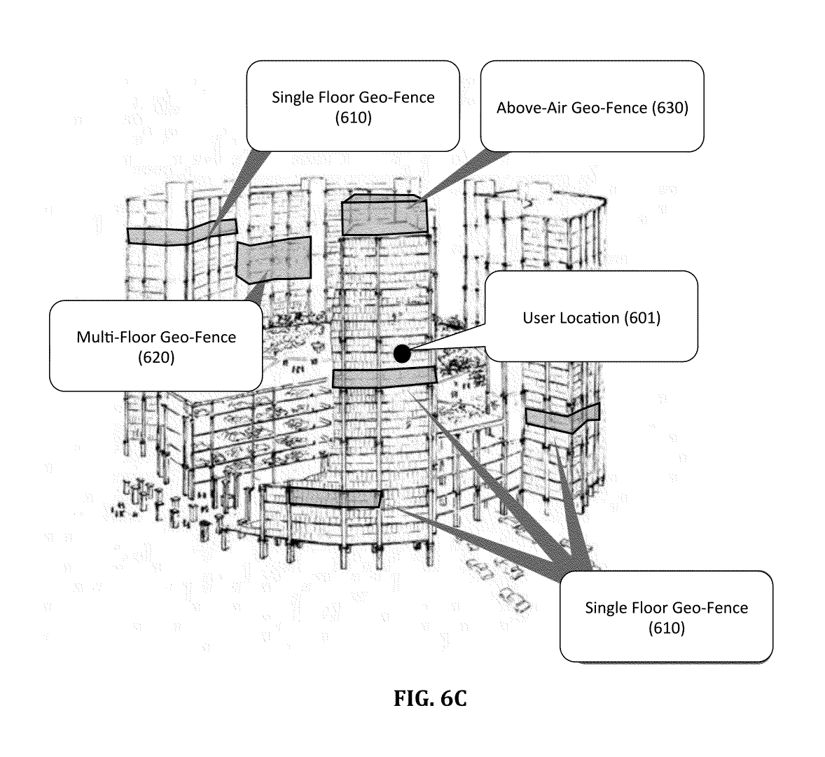

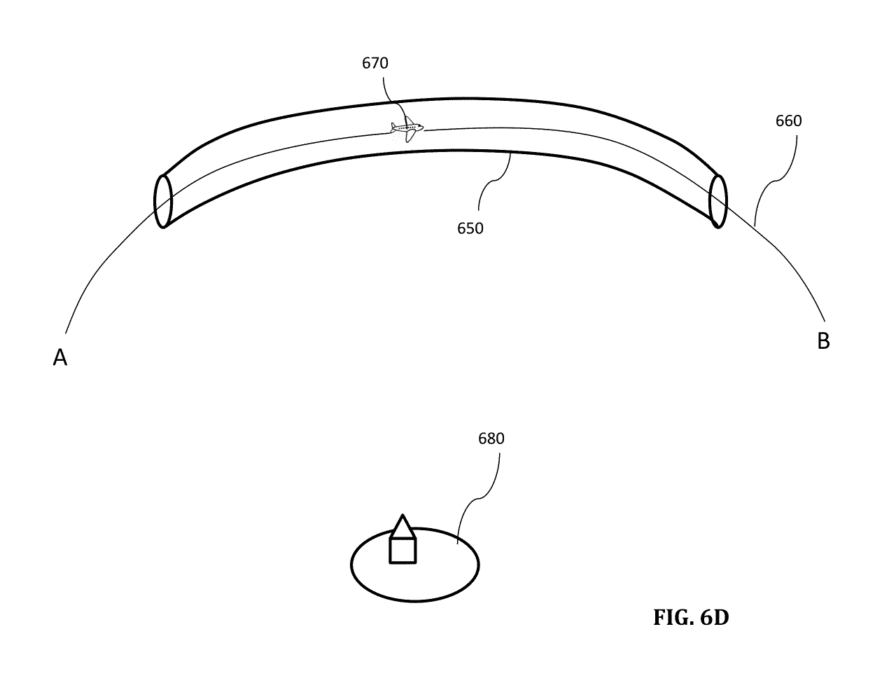

FIGS. 4A-5D illustrate examples of two-dimensional (2D) geo-fences, which are useful in location-based advertising where businesses occupy separate geographical areas. They are less suitable when different kinds of businesses are stacked on top of each other in a high-rise building complex, such as the one illustrated in FIG. 6A. For example, as shown in FIG. 6B, the 2-D polygon geo-fences 600 triggered by a user location 601 on the 10^{th} floor of a high-rise complex shown in FIG. 6A cannot be easily used to select an advertisement for a particular business occupying a particular floor of the building complex when multiple businesses in the building complex are targeting the same geographical fence 600.

In certain embodiments, the geo-fence definition system 300 further includes a 3-D enhancement module 340 that provides enhanced geo-fencing solutions to targeted three-dimensional (3-D) positions. As shown in FIG. 6C, instead of, or in addition to, the 2-D polygon geo-fences in FIG. 6B, the 3-D enhancement module 340 computes 3-D enhanced geo-fences 610, 620, and/or 630, that mirror single-floor, multi-floor, and/or above-air spaces or volumes, respectively, in or around the building complex.

In certain embodiments, the 3-D geo-fences are digitally fenced volumes (or campaign spaces), such as three-dimensional polygon fences that wrap around real-world objects (e.g. parts of buildings, underground spaces, mountain summits, etc.). They can be volumes/spaces specified by marketers, such as floors in multi-story shopping malls, etc as shown in FIG. 6C. For example, a simple 3-D geo-fence may be represented by a 2-D stamp (e.g., its projection onto the ground), which may be in the form of a 2-D polygon or an arbitrarily-shaped 2-D area, and an altitude span (e.g., from the 3rd floor to the 5th floor of a building), both of which can be dynamic depending on the time of the day, day of the week, etc. For example, sections of a building can be dynamically or otherwise included and excluded by an ad campaign according to campaign specifications.

In certain embodiments, the 3-D enhancement module 340 may determine for each POI for which geo-fences are being generated, whether the particular POI is suitable for 3-D geo-fencing. Such determination may be based on whether the POI is on a particular floor of a multi-story building or whether an ad campaign for or against the POI has requested 3-D geo-fencing. In certain embodiments, even a POI that is not situated in high-rise buildings may desire 3-D geo-fencing. For example, a business may desire to target mobile users on flights from city A toward city B. In such cases, as shown in FIG. 6D, the 3-D geo-fences may include a virtual tube 650 stretching along part of or the entire length of a flight path 660 of one or more of the flights flying from city A to city B. Thus, a mobile device 670 in an airplance in the flight path 660 would trigger the 3-D geo-fence 650 instead of, or in additional to, a 2D geo-fence 680 for a business on the ground under the airplane.

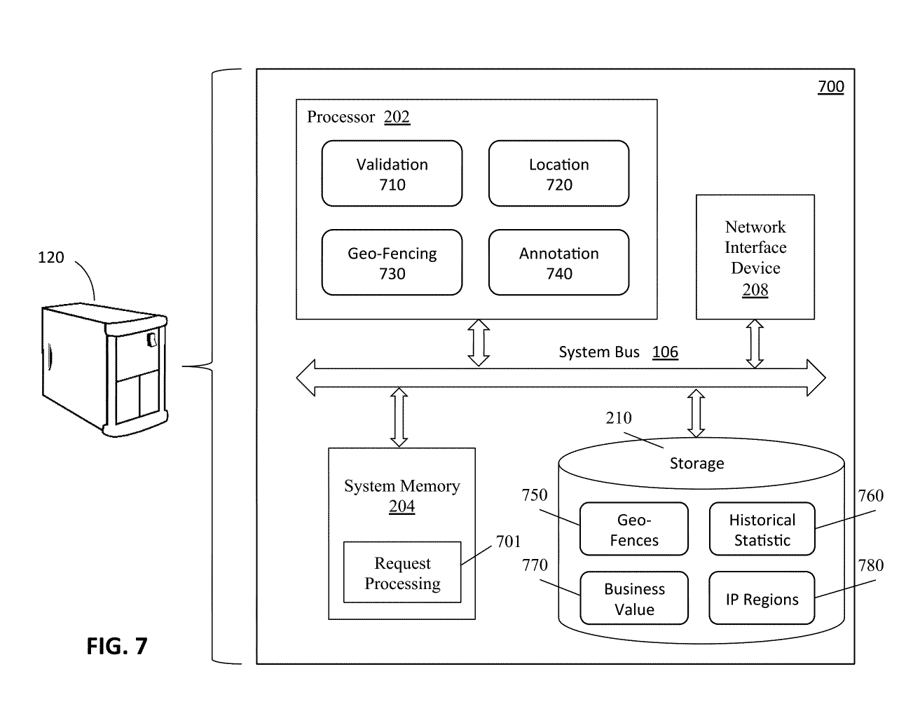

FIG. 7 is a diagrammatic representation of a request processing system 700 provided by a computer/server system 120 that processes mobile ad requests received from the network 100 according to certain embodiments. As shown in FIG. 7, the processor 202 in the computer/server system 120, when executing an ad request processing software program 701 loaded in the main memory 204, provides the request processing system 700 including a validation module 710, a location module 720, a geo-fencing module 730, and an annotation module 740. The system 700 makes use of a plurality databases storing data used and/or generated by the request processing software program 701, including a database 750 for storing the geo-fences generated by the geo-fence definition system 300, a database 760 for storing historical/statistical data, a database 770 for storing business value information, and a database 780 for storing IP regions corresponding to respective IP addresses of a collection of WiFi hotspots 135 and cellular towers 101a. Any or all of these databases can be located in the storage 210, or in another server/computer 120 and/or NAS 121 in the network 100, which the process 202 can access via the network interface device 208.

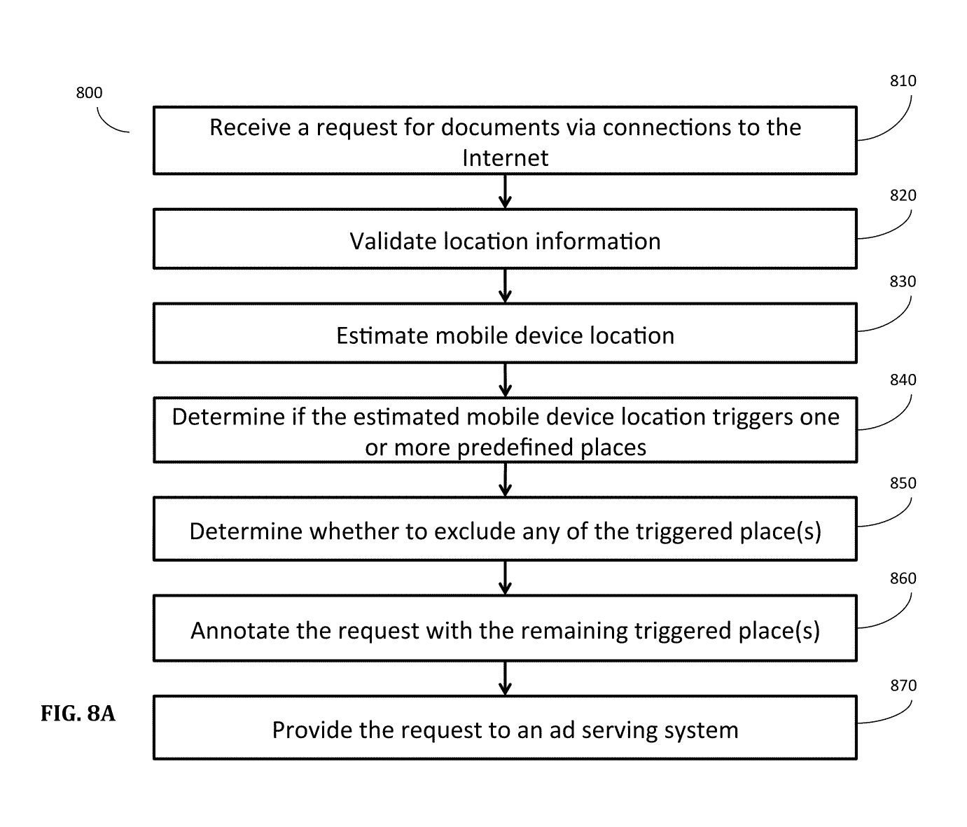

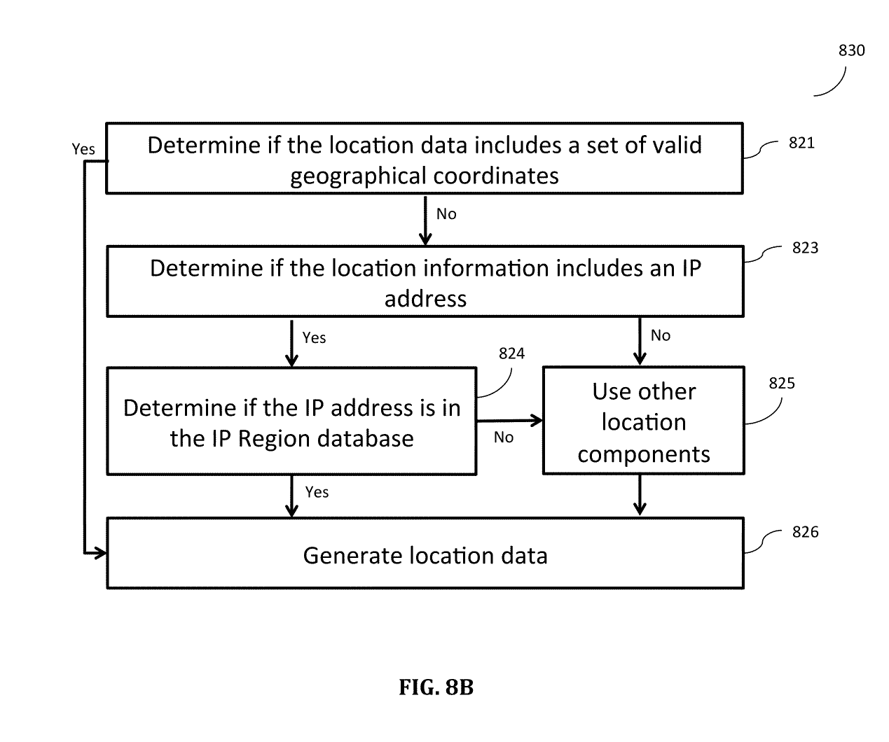

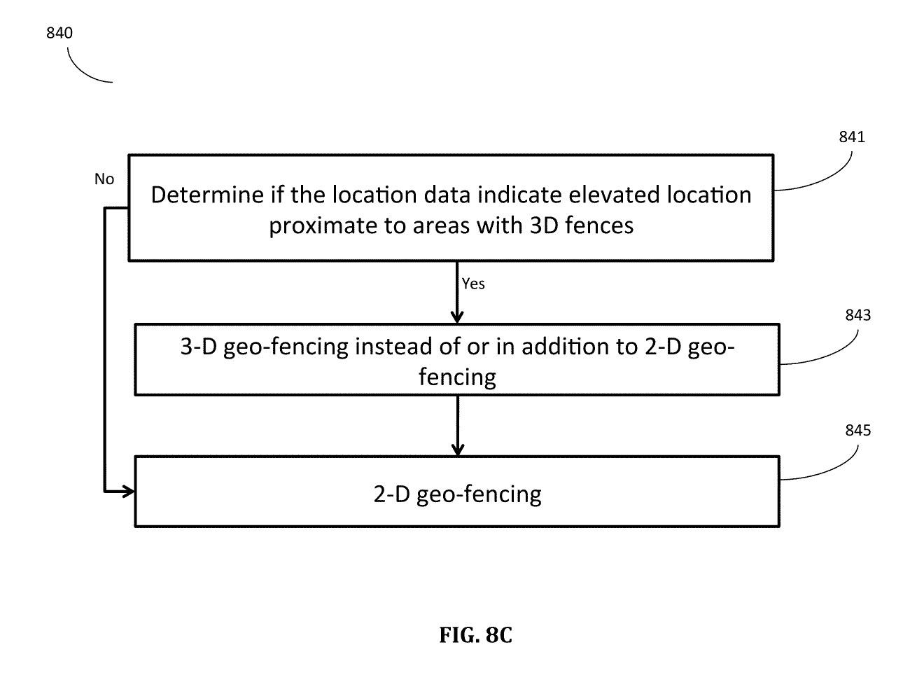

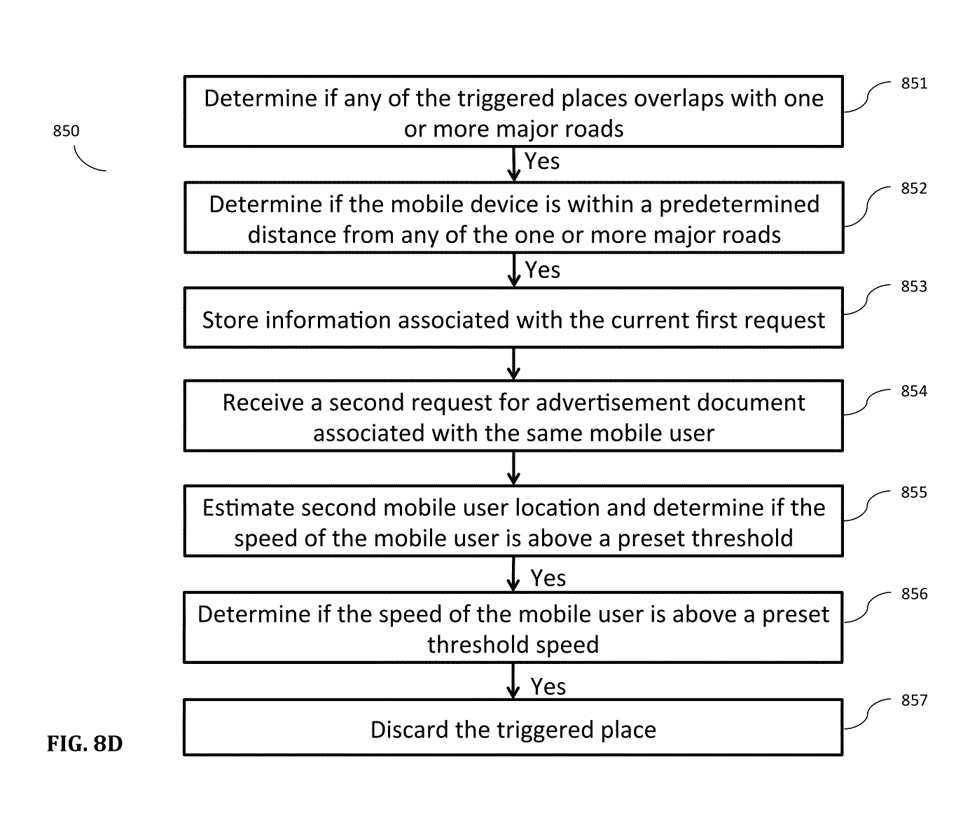

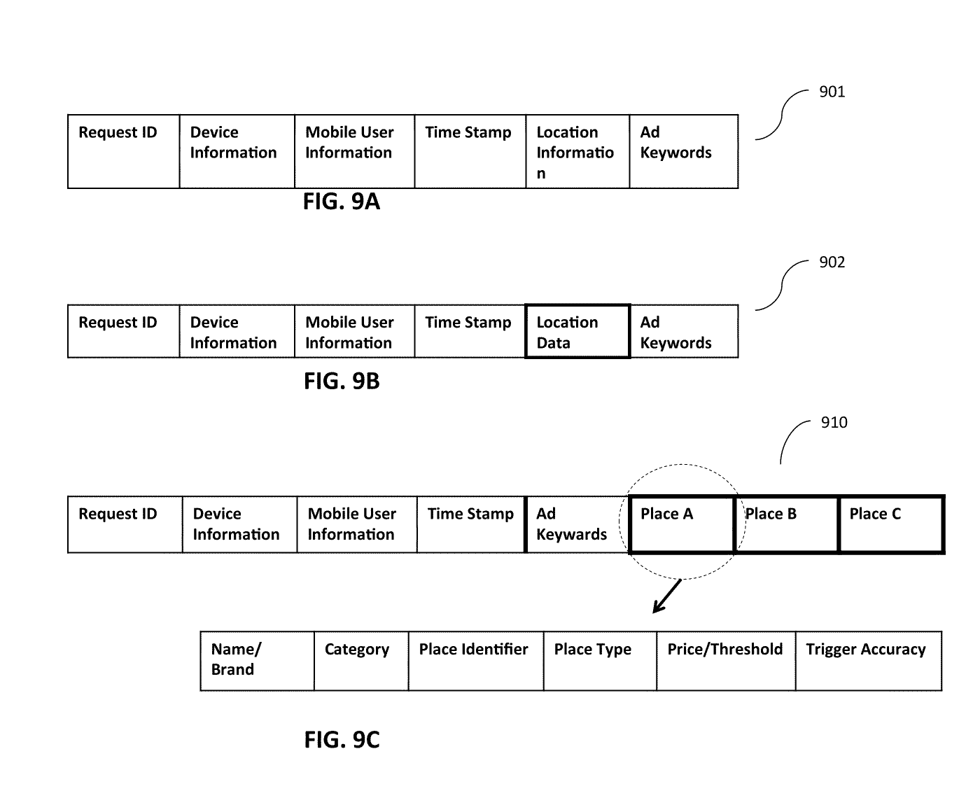

FIG. 8A is a flowchart illustrating a method 800 performed by the request processing system 700 according to certain embodiments. As shown in FIG. 8A, the system 700 receives (810) an ad request via connections 208, 208a to a network (e.g., the Internet). The ad request may come from a mobile publisher or any web service provider, with whom a mobile user has initiated interaction using his/her mobile device 130 via one or more web services or applications provided by the mobile publisher. The ad request may also be initiated by a software development kit (SDK) provided by a supply side platform (SSP). The ad request may also be provided by, for example, an ad middleman, an ad exchange, or any ad service provider. The ad request includes mobile device location information including a plurality of location components, such as latitude and longitude coordinates (LL), IP addresses (IP), postal or zip codes (ZC), and/or city-state names (CS), etc, in addition to other information, as discussed in further detail below with reference to FIGS. 9A-9C. The ad request may also include an altitude coordinate, which can be used to indicate an elevated location of the mobile device.

In certain embodiments, the validation module 710 validates (820) the location information by checking the validity and consistency of the location components and by weeding out any invalid location component(s). Generally, the LL is usually believed to be the most useful location component. However, when a user doesn't allow his/her location information to be known, mobile applications typically provide only coarse location data in the form of, for example, an IP address, a ZC (e.g. entered by the user at the time of registration), or CS. Thus, mobile applications and publishers frequently provide LLs obtained from geo-coding software, which translates ZC, CS, and other points of interests into one representative LL. In one embodiment, such representative LLs are categorized as “bad LLs”. A bad LL can be, for example:

1. A centroid of a ZC/CS
2. Any fixed point on a map (e.g. (0,0) or an arbitrary location)

In certain embodiments, the validation module 710 weeds out the bad LL's, so that location data with bad LL's are not provided to the next stage processing in the system 700, by using the techniques disclosed in commonly owned U.S. patent application entitled “System and Method for Deriving Probabilistic Mobile User Locations,” filed on even date herewith.

The location module 720 estimates (830) the location of the mobile device from the ad request and generates location data to represent an estimated mobile device location, which may be a geographical point or one or more probably areas or regions the mobile device is estimated to be in. The geo-fencing module 730 queries the geo-fence database 750 with the location data to determine (840) whether the location data triggers one or more predefined places in the database 750. The geo-fencing module 730 may further determine (850) whether any of the triggered place(s) should be excluded or discarded, as discussed in further detail below. The annotation module 740 annotates (860) the ad request with the triggered place(s), as discussed in further detail below. The annotated request is provided to an ad serving system, such as the ad serving system 1900 described below, which can be in the same computer/server system 120 or a different computer/server system 120 in the network 100. The ad serving system can be an ad server, an ad exchange or market place. The system 700 transmits the annotated ad request to the ad serving system via the network interface device 208 if the ad serving system is in a different computer/server system.

FIG. 8B is a flowchart illustrating a location process 830 performed by the location module (720) to generate (830) the location data. As shown in FIG. 8B, the location module determines (821) whether the validated location components include a set of geographical coordinates (e.g., LL), and whether the set of LL is valid or geo-precise LL. If the set of LL is determined to be valid or geo-precise LL (i.e., true LL), the location module 720 would use the LL as the location data to represent an estimated mobile device location. On the other hand, if the validated location components do not include a set of LL or the set of LL is not true LL, the location module 720 determines (823) whether the validated location components include an IP address. If the validated location components include an IP address, the location module then determines (824) if the IP address is in the IP region database 780. If the IP address is in the IP region database 780, the location module generates (826) the location data using a derived IP region associated with the IP address in the IP region database 780. The location data may include geographical points representing the IP region itself or its center location with some function of the inverse of a size of the IP region as a confidence factor. On the other hand, if the location data does not include an IP address or the IP address is not found or associated with a derived IP region in the IP region database, the location engine would use (825) other location components to generate (826) location data, or use external IP vendor databases to resolve an IP to other location components first and then use (825) the other location components to generate (826) location data. In certain embodiments, the location data generated using the other location components include one or more weighted probable areas, as disclosed in commonly-owned U.S. patent application Ser. No. 13/867,021, filed Apr. 19, 2013, entitled “Method and Apparatus for Probabilistic User Location,” which has been incorporated herein by reference in its entirety.

FIG. 8C is a flowchart illustrating a geo-fencing process 840 performed by the geo-fencing module 730 to determine (840) whether the location data triggers one or more predefined places in the database 750. As shown in FIG. 8C, the geo-fencing module 730 may determine (841) whether the location data indicate that the mobile device 130 is at an elevated location that is proximate to geographical areas where 3D geo-fences are more suitable (e.g., commercial areas with highrise buildings). If the true, the geo-fencing module 730 would try to find 3-D geo-fence(s) in the database 750, which may enclose or overlap with the estimated mobile device location represented by the location data. If not, the geo-fencing module would try to find 2-D geo-fence(s) in the database 750, which may enclose or overlap with the estimated mobile device location represented by the location data. The 2-D or 3-D geo-fence(s) thus found are referred to as being triggered by the location data.

FIG. 8D is a flowchart illustrating a process 850 for determining whether any of the triggered geo-fences should be excluded or discarded according to certain embodiments. For example, as shown in FIG. 8D, the geo-fencing module 730 may determine (851) whether any of the triggered geo-fences overlaps with major roads, and may further determine (852) whether the mobile device 130 could be traveling on one of the major roads. This can be done, for example, by determining whether the location data indicate that the mobile device is within boundaries set for any one of the one or more major roads, or within a predetermined distance from any of the one or more major roads. In certain embodiments, further steps are taken to verify that the mobile device is traveling on a major road. For example, information such as location data and a time stamp associated with the current ad request is stored, and used together with the location data and time stamp of a subsequent request associated with the same device to determine a speed of the mobile device. The triggered geo-fence overlapping with a major road can be excluded or discarded if it is determined that the mobile device is traveling on the major road. Or, if an ad campaign actually targets the mobile devices traveling on the major road and a different geo-fence for that ad campaign would be attached to the ad request.

In certain embodiments, as shown in FIG. 9A, the ad request 901 received from the Internet by the request processing system 700 includes other information as well as the location information, such as information about the the mobile device and/or a mobile user associated with the mobile device, a time stamp indicating the time of the ad request (e.g., day, hour, minute, etc.), one or more keywords suggesting types of ads for returning to the mobile device, and/or other information associated with the mobile user, the mobile device, and/or the sender of the ad request. In certain embodiments, the location module 720 derives location data from the ad request and replaces the location information in the ad request with the location data to generate a modified ad request 902, as shown in FIG. 9B. The location module 720 may further convert the location data into spatial index representing the same, for ease of use by the geo-fencing module 730.

In certain embodiments, if the location data trigger a pre-defined place or geo-fence, the annotation module 740 annotates the ad request 901 by attaching the triggered place to the ad request or by replacing the location information in the ad request 901 or the location data in the modified ad request 902 with the triggered place, as shown in FIG. 9C. In some cases, the location data can trigger multiple places. For example, as shown in FIG. 4B, an ad request that triggers the BC place 410 of Costco Almaden also triggers the BR place 430 of any of the stores in the same business region. Thus, the ad request may be annotated with the BC place of Costco Almaden and the BR place of one or more other stores in the same business region. As shown in FIG. 9C, each of the one or more places or geo-fences includes either or both of a business name and a brand name, with which the place is associated. For some businesses, the business name and the brand name are the same so only one is required. Each of the one or more places may also include a category of the products or services (e.g., grocery, general merchandise, park/recreation, sports, home improvement, etc.) associated with the business/brand name, and a location of the place (e.g., country/state/city), and a place type (e.g., BC, BP, or BR), some or all of which can be included in the annotated ad request 910. In certain embodiments, a places or geo-fences may also includes a suggested price or a threshold price for sending an ad to the mobile device or for bidding for an ad to be sent to the mobile device, as discussed in further detail below.

In certain embodiments, a trigger accuracy is computed and is attached to the place to give mobile advertisers another metric on which to decide whether to bid for the supply and how to price their bids accordingly. The trigger accuracy may be measured by the confidence factor of the estimated mobile device location and/or by the relative proximity of the mobile device from a centroid of the place vs. from the closest edge of the place, or a percentage of the portion of the probable regions of the mobile device overlapping the place. Thus, an ad request associated with a mobile device found to be very close to the edge of the place or whose one or more probable regions barely overlap with the place can be priced differently from an ad request associated with a mobile device found to be very close to the centroid of the place or its one or more probable regions substantially overlap with the place.

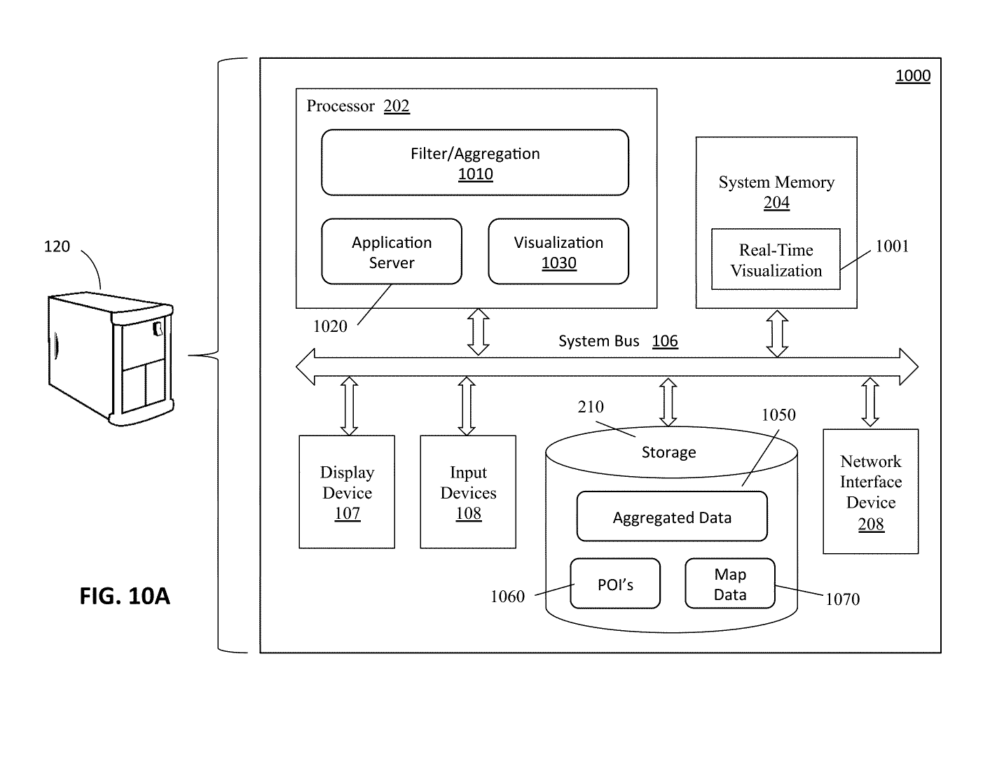

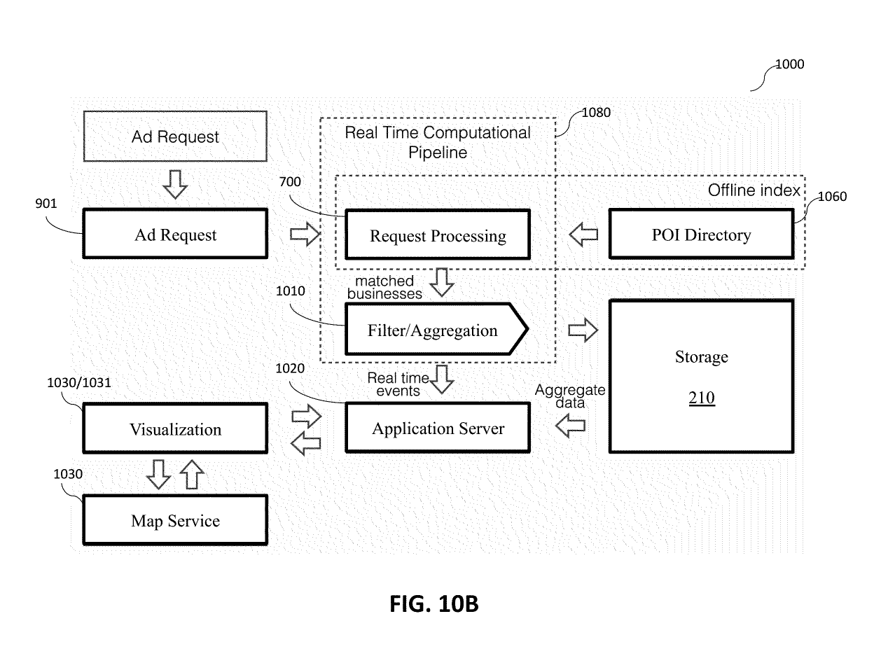

FIG. 10A is a diagrammatic representation of a real-time ad event visualization system 1000 provided by a computer/server system 120 according to certain embodiments. In certain embodiments, the real-time ad event visualization system 1000 provides a map-based system for visualizing real-time location-based events of geo-fences or places being triggered by mobile ad requests, indicating events such as people entering, staying within and exiting geographic locations of interest, such as stores. Herein, the term “store” refers to a business or place of commerce or for conducting certain activities with a very specific geographical location, such as a shopping mall, a brick-and-mortar store in a shopping mall, an office building, a park, gym, school, theatre, restaurant, etc. As shown in FIG. 10A, the processor 202 in the computer/server system 120, when executing a real-time visualization software program 1001 loaded in the main memory 204, provides the real-time ad event visualization system 1000 including a filter/aggregation module 1010, an application server module 1020, and a visualization module 1030. The system 1000 makes use of a plurality databases storing data used and/or generated by the real-time visualization software program 1001, including a database 1050 for storing aggregated data generated by the filter/aggregation module 1010, a database 1060 storing a Point of Interest (POI) directory, and a database 1070 for storing map data. Any or all of these databases can be located in the storage 210, or in another server/computer 120 and/or NAS 121 in the network 100, which the process 202 can access via the network interface device 208.

FIG. 10B is a flow diagram of the real-time ad event visualization system 1000 interacting with other systems/services either locally (i.e., within the same computer/server system 120) or across a network (e.g., the Internet 110 or a local area network 111). As shown in FIG. 10B, the ad event visualization system 1000 includes a real-time computational pipeline, in which an ad request processing system, such as the ad request processing system 700 discussed above, processes an ad request (e.g., the ad request 901 shown in FIG. 9A) to determine if the ad request triggers any of the geo-fences stored in a geo-fence database (e.g., database 750. The ad request processing system 700 may be provided by the same computer/server 120 that also provides the real-time ad event visualization system 1000, or by a different computer/server 120 in a local or wide-area network. The ad request processing system 700 provides the annotated ad request 910 including information such as the location data and/or the triggered places or geo-fences to the real-time ad event visualization system 1000. Alternatively, the ad request processing system 700 may just provide the modified ad request 902 with or without other information such as information about the triggered places or geo-fences to the real-time ad event visualization system 1000.

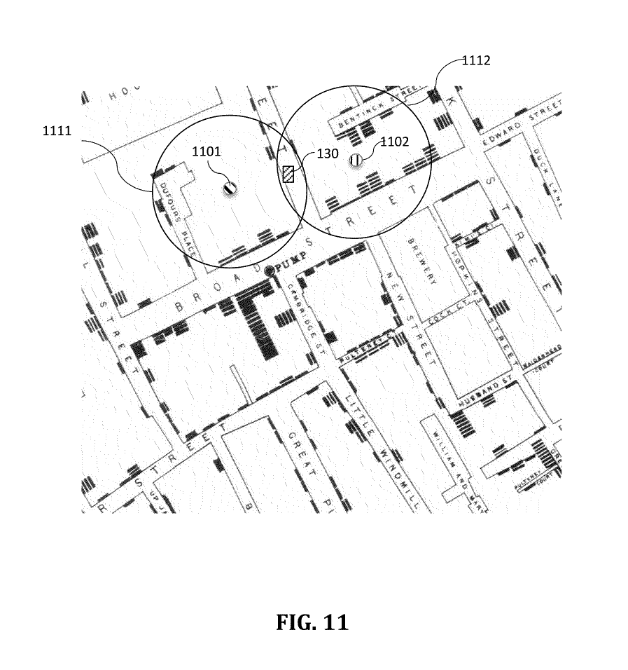

In certain embodiments, the filter/aggregation module 1010, which is also in the real-time computational pipeline, filters the processed ad requests provided by the ad processing system 700 to detect real-time location-based events. For example, processed ad requests 902 or 910 can be filtered out based on characteristics of the associated mobile users, such as age, gender, etc. As another example, if a mobile user happens to be located in two or more overlapping geo-fences associated with multiple stores at the same time, multiple geo-fences or places can be provided. In this case, data associated with the multiple geo-fences or places are compared to determine which of the multiple stores the mobile user is more of interests, and only one of the geo-fences or places is kept and the other geo-fences or places are filtered out. For example, as shown in FIG. 11, the ad request could be associated with a mobile user 130 in an overlapped area of two geo-fences 1111 and 1112 for two different businesses. If the ad processing system 700 provides the user location and the one or more geo-fences as the triggered geo-fences or places, the filter/aggregation module 1010 would select the geo-fence whose center or centroid 1101 or 1102 is closer to the mobile user 130, and record that the mobile user being in the selected geo-fence as a detected real-time location-based event.

The filter/aggregation module 1010 can also select a triggered place out of multiple triggered places using other information in the triggered places, such as brand name, category, place type, trigger accuracy, etc. In certain embodiments, the ad processing system 700 can provide one or more target areas with associated probabilities as geo-fences or places. The filter/aggregation module 1010 can select the target area with the highest probability as being associated with the detected real-time location-based event. In another embodiment, The filter/aggregation module 1010 could also perform a coin toss using the probabilities associated with the target areas as weight to select the target area for the real-time location-based event. In a further embodiment, techniques described in commonly owned U.S. patent application Ser. No. 13/867,029, filed Apr. 19, 2013, entitled “Method and Apparatus for Geographical Document Retrieval,” could be used to select the target area for the real-time location-based event.

The filter/aggregation module 1010 is further configured to aggregate historical/statistical data related to detected real-time location-based events and store the aggregated historical/statistical data in the database 1050. For example, the aggregated historical/statistical data may include counts of visits by mobile users to a particular store, a particular brand, a particular business category, and affinity data including counts of visits by mobile users to stores, brands, categories related to a particular store, brand, business category, etc., over periods of time such as a day, a week, or a month before the real-time location-based event. For example, each time a real-time location-based event of a mobile user being at a business is detected, the count for the total number of real-time location-based events for that business/brand is increased by one count. At the same time, the count for the total number of real-time location-based events for each of one or more categories to which the business/brand belongs is also increased by one count.

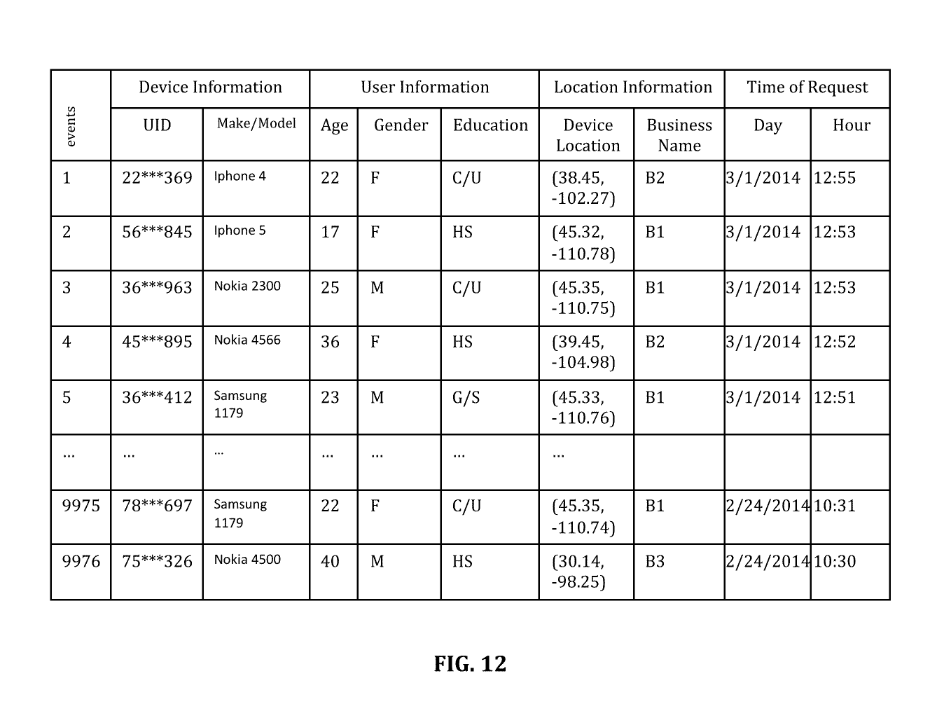

In certain embodiments, the filter/aggregation module 1010 may also temporarily store real-time location-based events in the digital storage (e.g., main memory 204, static memory 206, or storage 210) so that the number of mobile users remaining at or exiting any particular store can be tracked. FIG. 12 illustrates a few examples of real-time location-based events stored in the digital storage. For example, if a current real-time location-based event at a certain business is detected within a predetermined time period (e.g., one hour) after a previous real-time location-based event associated with the same mobile device at a previous business that is different from the current business, the user of the mobile device is regarded as having left the previous business. In this case, a User Exit event associated with the previous business is noted. By subtracting the number of User Exit events associated with a business in a certain time period from the number of real-time location-based events associated with the same business in the same time period, the number of mobile users remaining at that business can be estimated and this number can also be displayed in response to operator request for same. In some embodiments, the filtering/aggregation module may estimate the number of mobile users remaining at a business based one or more mobile devices which have triggered the geo-fence of that business are subsequently found outside of that geo-fence, even if not at another geo-fence.

In certain embodiments, if a current real-time location-based event at a certain business is detected within a predetermined time period (e.g., one hour) after a previous real-time location-based event associated with the same mobile device at the same business, the current real-time location-based event is regarded as the same real-time location-based event as the previous real-time location-based event because the user of the mobile device may simply be staying at the certain business during a single visit. In such a case, no aggregation is done on the historical/statistical data associated with this business.

FIG. 10B shows the real-time computational pineline making use of an offline index databases such as InfoUSA (www.infousa.com), which provides a list of businesses and their locations in Standard Industrial Classification (SiC) code, or areas specified by marketers, such as cities, states, areas associated with shopping malls or shops, tourist attractions or certain zip codes, and which can be used instead of, or in addition to, the POI directory in the database 1070, according to certain embodiments.

The application server (app server) module 1020 interacts with the visualization module 1030 or corresponding client visualization applications 1031 installed on one or more client computer/server systems 120 in the network 100 through various protocols such as HTTP. The app server 1020 is configured to bridge the real time computational pipeline in the system 1000 to the client system. The app server 1020 also queries for aggregated data from the storage 210. The visualization module 1030 or the corresponding visualization app 1031 in a client system may include custom logic that utilizes the map data in database 1070 and/or mapping technologies provided by another computer/server system 120, so as to maximize visual appeal of displayed real-time location-based events while keeping up with the data streams. The app server 1020 organizes and pushes data associated with the real-time location based events and provides the aggregated historical/statistical data in response to demands for same from the visualization module 1030 and/or the client system, thus enabling the visualization module 1030 and/or the client system to display the real-time location based events on a map together with selected aggregated historical/statistical data, on a display device 107 of the system 1000, or a display device at the client system, in response to operator inputs via, for example, an input device 108 in the system 1000 or the client system.

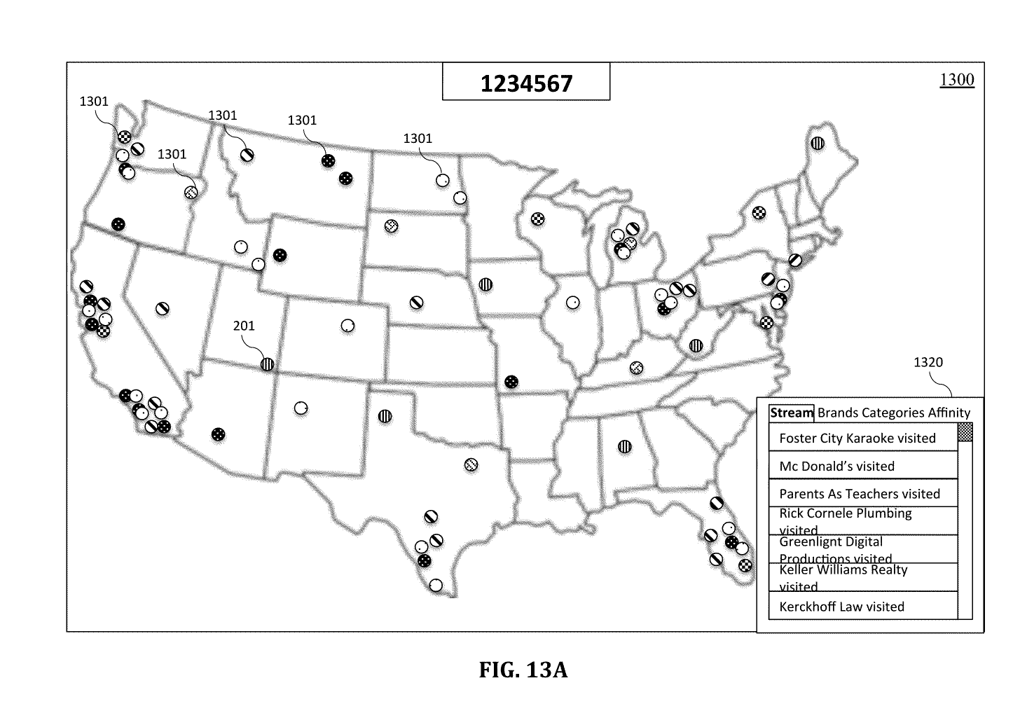

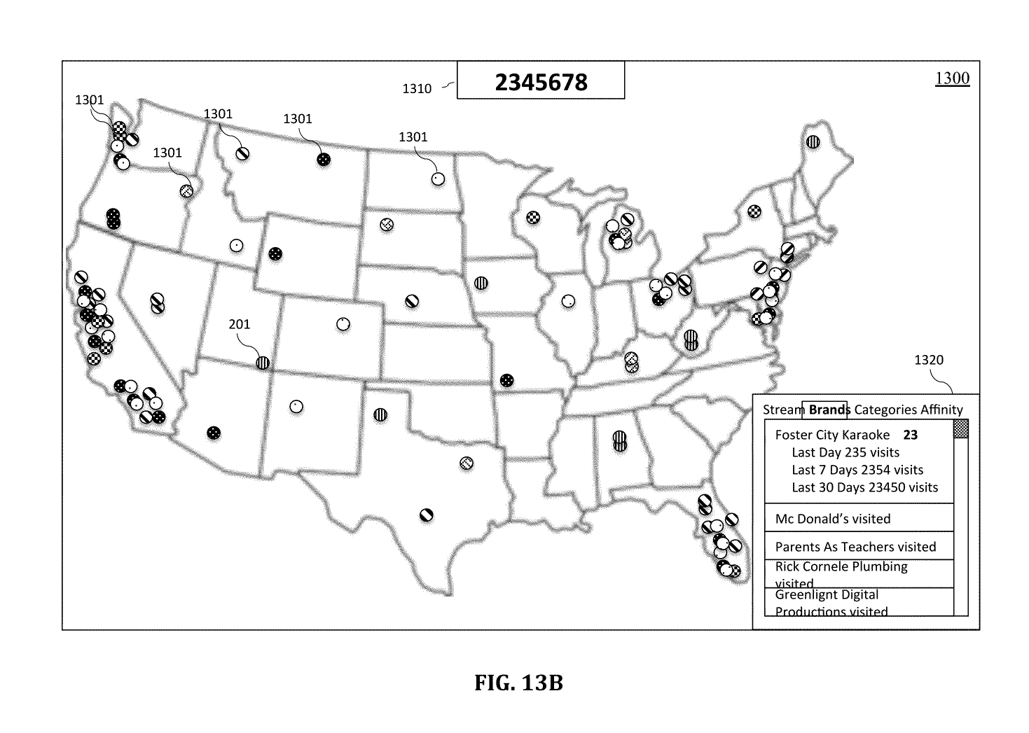

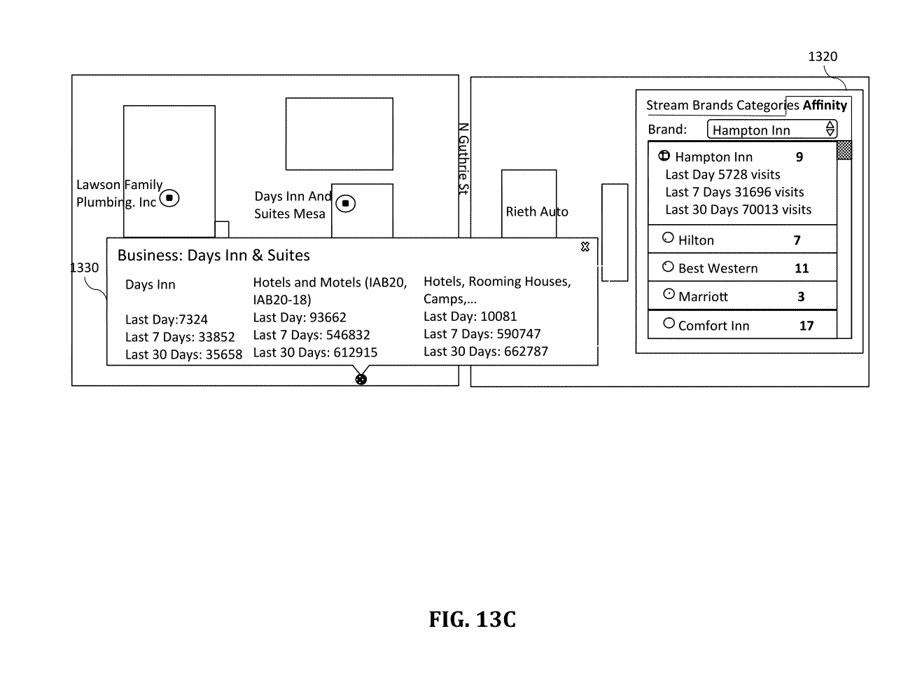

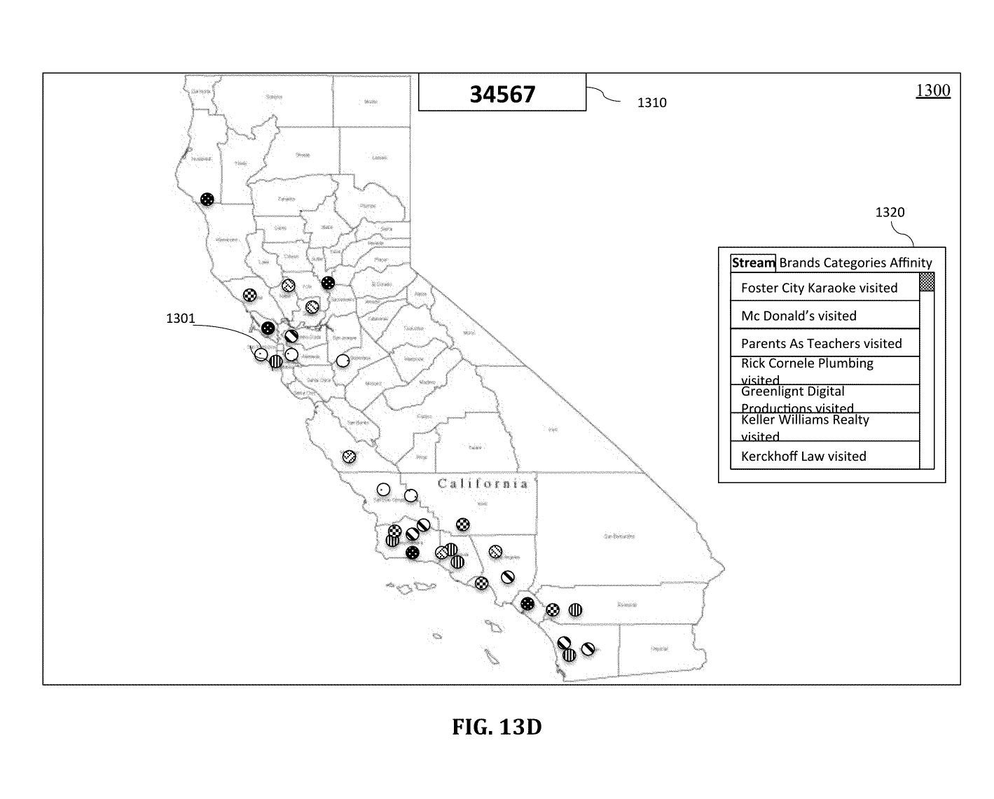

In certain embodiment, a center location of the selected place is used as the location of the detected real-time event. As shown in FIG. 13A, when displayed by the system 1000 or by the client system, the real-time location-based events can be flickering dots on a map (e.g. the map of United States if an operator so specifies). Each time a real-time location-based event is detected, a dot would appear at the location associated with the real-time location-based event. Or, if there has been a dot at the location already due to a previous real-time location-based event at the location not long ago, the dot would flicker to indicate a new real-time location-based event. Different colored dots can be used to represent different businesses, brands or categories, as shown in FIG. 13A, where the different patterns in the dots are used to indicate their differences in color. An area 1310 on the screen is used to display a total number of real-time location-based events since, for example, when the client application is started, or during a period of time (e.g., in the past 10 minutes) based on a default setting or operator specification. Thus, this total number is a real-time number that changes as new real-time location-based events are detected. Another area 1320 on the screen can be used to display mostly historical/statistical data. In certain embodiments, different historical/statistical data can be displayed under different tabs, which can be selected by, for example, mouse clicks, or keyboard entry (not shown).

For example, each time a client application 1131 is started, a signal is transmitted from the associated client system to the app server 1120 and the app server 1120 would start to push real-time location-based events to the client system. An operator at the client server can choose what historical/statistical data to display on the screen either separately or together with the real-time location-based events. For example, the historical/statistical can be displayed under any one of a plurality of tabs, such as a stream tab, a brand tab, a category tab, and an affinity tab. The stream tab can be selected by default when the client application is launched. Under the stream tab, as shown in FIG. 13A, business/brand/category names associated with real-time location-based events are displayed. These names change as new real-time location-based events are detected.

Under the brand tab, as shown in FIG. 13B, brand names are displayed. An operator at the client side can scroll down to see all of the brand names that are being considered for real-time location-based events. When the operator selects a brand name, for example, by a mouse click, historical/statistical data associated with that brand may appear. As shown in FIG. 13B, when the Foster City Karaoke brand is selected, the number 23 next to the brand name indicates the number of real-time location-based events since the application started. Below the brand name, other historical/statistical data such as the numbers of visits by mobile users to this brand in the last day, the 7 days, the last 30 days can also be displayed.

Similarly, under the category tab, category names are displayed. An operator at the client side can scroll down to see all of the category names that are being considered for real-time location-based events. When the operator selects a category name, for example, by mouse click, historical/statistical data associated with that category may appear. When a category name is selected, the number next to the brand name indicates the number of real-time location-based events since the application started. Below the category name, other historical/statistical data such as the numbers of visits by mobile users to this category in the last day, the 7 days, the last 30 days can also be displayed. In certain embodiments, when a category is selected, only location-based events associated with the selected category are displayed on the map and new events in that category are added as they occur in real time.

In certain embodiments, the historical/statistical data also includes affinity data such as counts of location-based events associated with businesses having one or more characteristics similar to corresponding characteristics of a selected business. Mobile advertisers can use the affinity data to gauge how frequently a particular business/brand is visited by mobile users as compared to other businesses/brands within the same categories.

As another example of displaying historical/statistical data, when the affinity tab is selected, a small area under the affinity tab is provided for selecting a brand/business name, for which affinity information is requested. Once a brand/business name is provided or selected, historical/statistical data associated with the selected brand/business together with historical/statistical data associated with other brand/business in the same category can be displayed. As shown in FIG. 13C, a pop-up window 1330 displaying historical/statistical data for a brand, together with historical/statistical data for one or more categories associated with a particular brand, can also be displayed, if the particular brand is either selected in the area 1320, or the operator zoomed in to the location of a business/store of the particular brand.

In certain embodiments, the operator can select a geographical region, such as a country, state, city, or a shopping mall, to display real-time location-based events occurring in the geographical region. For example, FIG. 13D shows a display of real-time location-based events in California, a total number of real-time location-based events in California since the start of the client application displayed in screen area 1310, and aggregated historical/statistical data associated with the real-time location-based events in California, which can be displayed in screen area 1320.

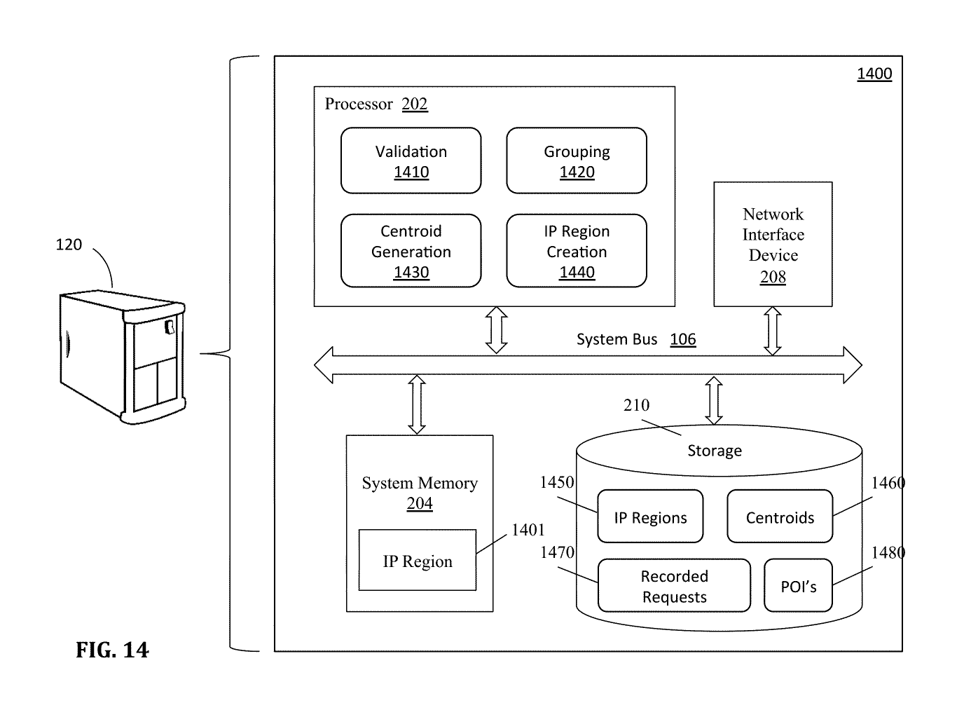

FIG. 14 is a diagrammatic representation of an IP region system 1400 provided by a computer/server system 120 according to certain embodiments. As discussed above, an IP region can be used as probable locations to select from when a request comes with an IP address but without accurate geographical coordinates. The IP region system 1400 derives IP regions corresponding to respective IP addresses using ad requests including the respective IP addresses that have been received over a period of time (e.g., a few days). As shown in FIG. 14, the processor 202 in the computer/server system 120, when executing an IP region software program 1401 loaded in the main memory 204, provides the IP region system 1400 including a validation module 1410, a grouping module 1420, a centroid generation module 1430, and a IP region creation module 1440. The system 1400 makes use of a plurality databases storing data used and/or generated by the IP region software program 1401, including a database 1450 for storing IP regions generated by the IP region creation module 1440, a database 1460 storing the centroids generated by the centroid generation module 1430, a database 1470 for storing received ad requests, and a database 1480 for storing a Point of Interest (POI) directory. Any or all of these databases can be located in the storage 210, or in another server/computer 120 and/or NAS 121 in the network 100, which the process 202 can access via the network interface device 208.

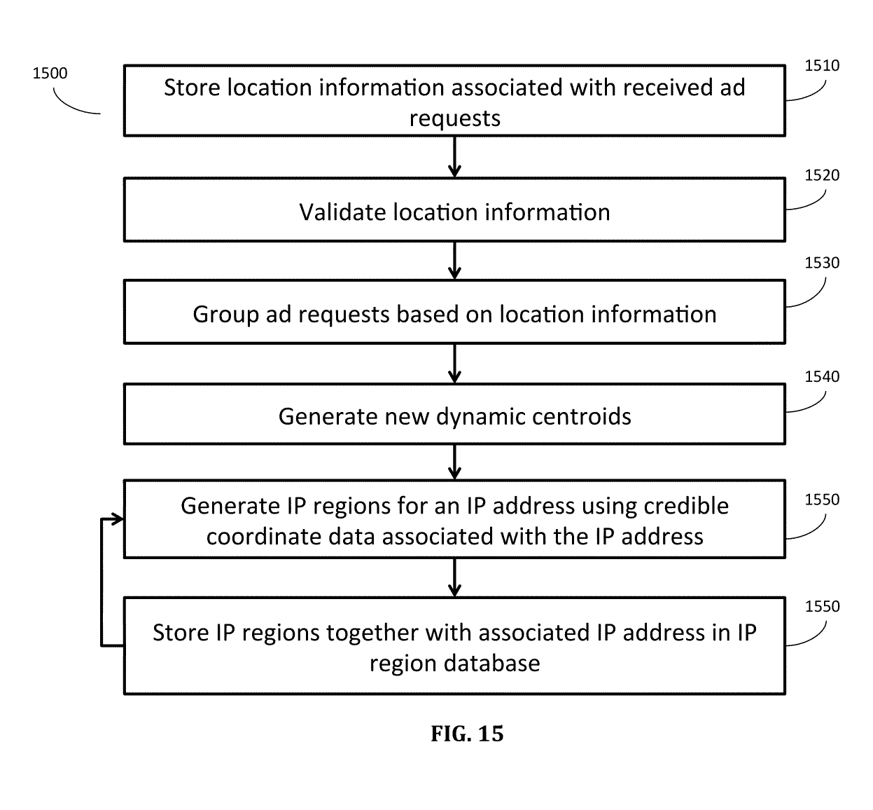

FIG. 15 is a flowchart illustrating a method 1500 performed by the IP region system 1400 to derive IP regions for respective IP addresses according to certain embodiments. As shown in FIG. 15, when ad requests traffic come in, the IP region system stores (1510) at least the location information of the ad requests in the database 1450. After a certain period of time (e.g., a few days), the IP region system 1400 performs the method 1500 to derive IP regions from the stored location information. The validation module 1410 examines (1520) the LLs in the stored location information to determine whether each set of LL is a true LL (i.e., representing actual mobile device location). Based on the determination, the grouping module 1420 groups (1530) the requests or their respective location information into different traffic groups, such as the following:
1. T(IP, TLL)—Each request in this group has an IP and also a valid geo-precise LL;
2. T(IP, DLL_Static)—Each request in this group has an IP and a derived LL that correspond to a static centroid, i.e., a centroid derived from geographic mapping (e.g., a city center) or IP vendor mapping;
3. T(IP, DLL_Dynamic)—Each request in this group has an IP and a derived LL that is not a static centroid;
4. T(NoIP, TLL)—Each request in this group has a valid geo-precise LL but no IP;
5. T(NoIP, DLL_Static)—Each request in this group has a derived LL corresponding to a static centroid but no IP;
6. T(NoIP, DLL_Dynamic)—Each request in this group has a derived LL that is not a static centroid;
7. T(IP, NoLL)—Each request in this group has an IP but no LL.

In certain embodiments, the grouping module 1420 puts location information into the T(IP, DLL_Static) group if the location information has an IP address and the LL in the location information corresponds with LL of a static centroid stored in the centroid database. In certain embodiments, static centroids associated with well-know geographic regions such as cities, regions associated with zip codes, etc. are stored in the centroid database. If the LL of a request correspond to one of the static centroids, it is highly likely that this LL is not a true LL but an LL mobile publishers put together by referring to the city of the mobile user.

In certain embodiments, the grouping module 1420 puts location information into the T(IP, DLL_Dynamic) group if the location information has an IP address and the LL in the location information does not correspond with any of the static centroids in the centroid database but corresponds with the LL of a dynamic centroid (i.e., a centroid that occurs with this IP address very frequently or above a threshold in a given period—indicating another IP vendor's database being used by a publisher to derive the LL from an IP, while not being covered by known static IP centroids).

In certain embodiments, the grouping module 1420 puts location information into the T(NoIP, DLL_Static) group if the location information does not have an IP address and the LL in the location information corresponds with LL of a static centroid stored in the centroid database. In certain embodiments, static centroids associated with well-know geographic regions such as cities, regions associated with zip codes, etc. are stored in the centroid database. If the LL of a request correspond to one of the static centroids, it is highly likely that this LL is not a true LL but an LL mobile publishers put together by deriving from an IP address.

In certain embodiments, the grouping module 1420 puts location information into the T(NoIP, DLL_Dynamic) group if the location information does not have an IP address and the LL in the location information does not correspond with any of the static centroids in the centroid database but corresponds with the LL of a dynamic centroid (i.e., i.e., a centroid that occurs with this IP address very frequently or above a threshold in a given period—indicating another IP vendor's database being used by a publisher to derive the LL from an IP, while not being covered by known static IP centroids).

In certain embodiments, the grouping module 1420 puts location information into the T(IP, TLL) group if the location information has an IP address and the LL in the location information does not correspond with any of the static centroids in the centroid database, or any of the dynamic centroids in the dynamic centroid database 1460. Likewise, the grouping module 1420 put location information into the T(NoIP, TLL) group if the location information has no IP address and the LL in the location information does not correspond with any of the static centroids in the centroid database, or any of the dynamic centroids in the dynamic centroid database 1460.

In certain embodiments, the centroid module 1420 determines whether any of the location information in the T(IP, TLL) group actually includes derived LLs even though these LLs are not found in the dynamic centroid database 1460 or IP region database 1450, and creates (1540) a new dynamic centroids corresponding to these possibly derived LLs. For example, if a first number of requests made in a certain amount of time with the same IP and the same LL (or LLs in very close range with each other) is unusually large, it is likely that this same LL or closely spaced LLs are actually derived LLs for the IP address because these many mobile users are unlikely to be at the same spot in such a short period of time. The centroid module 1420 may check the POI database to see if the IP address is associated with a POI, which would host many mobile users. If not, the centroid module 1420 may use these LLs to derive (1540) a dynamic centroid and store this LL together with the IP address in the dynamic centroid database 1460. The IP region system 1400 may also take the first number of requests with this IP address and the same LL (or closely spaced LLs) out of the T(IP, TLL) group and put them into the T(IP, DLL_Dynamic) group.

As another example, if a second number of requests made in a certain amount of time with no IP and with a same LL (or closely spaced LLs) is unusually large, it is likely that this same LL (or closely spaced LLs) is actually a derived LL because these many mobile users are unlikely to be at the same LL in such short period of time. The centroid module 1420 may regard this LL (or closely spaced LLs) as a dynamic centroid and store this LL in the dynamic centroid database 1460. The grouping module 1410 may also take the second number of requests with no IP address and with the same LL (or closely spaced LLs) out of the T(NoIP, TLL) group and put them into the T(NoIP, DLL_Dynamic) group.

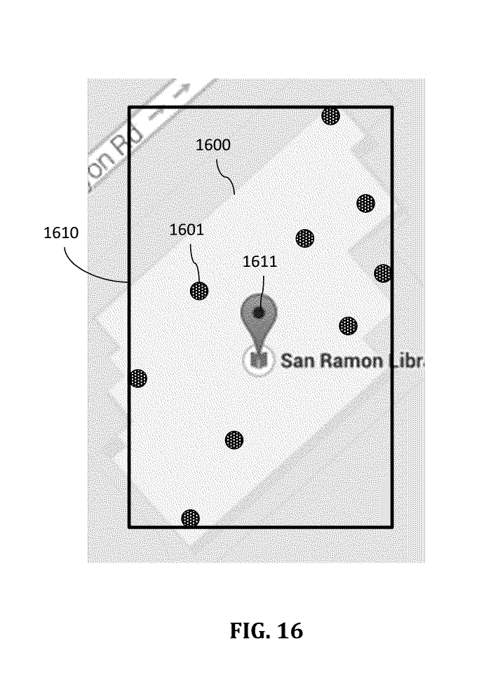

For each respective IP address in the surviving T(IP, TLL) group, the IP region creation module 1440 generates (1550), an IP region using the TLLs associated with this IP address in the T(IP, TLL) group. For example, as shown in FIG. 16, the TLLs 1601 associated with the IP address of a WiFi device at an establishment 1600 (e.g., a city library) are used to derive an IP region 1610, which is a polygon (e.g., rectangle) with a center location 1611 being a centroid derived from the TLLs 1601 and a size that is determined by the span of the TLLs in the T(IP, TLL) group. The IP region can be represented by a set of points, such as:

IP Region=(P₁,P₂, . . . ,Pₘ)

where a point, Pₘ, is given by

Pₘ=(Latitudeₘ,Longitudeₘ)

The center location 1611 is also stored as the centroid associated with the IP region 1610. By representing a region as a set of points, the resolution of a region can be set to arbitrary levels depending on the number of points. For example, a region with three points can be used to encode a triangular-shaped region, four points a rectangular-shaped region, etc.

Thus, IP regions are generated from ad requests that include IP addresses together with GPS-based LLs. Dynamic LL centroids and Dynamic IP centroids are some of the mechanisms to figure out bad LLs to weed them out, and thus not use in IPregion construction. In certain embodiments, certain true LLs are not used to derive dynamic LL centroids. For example, if an LL occurs only during day time, but not during night time, at a certain frequency, it is not considered for dynamic LL centroid derivation, since this could be a valid POI like library where the router's LL is being obtained. However, if an LL occurs above a certain frequency during night time when real users are unlikely to be present, it is assumed that it is derived LL and qualifies for use dynamic LL centroid derivation.

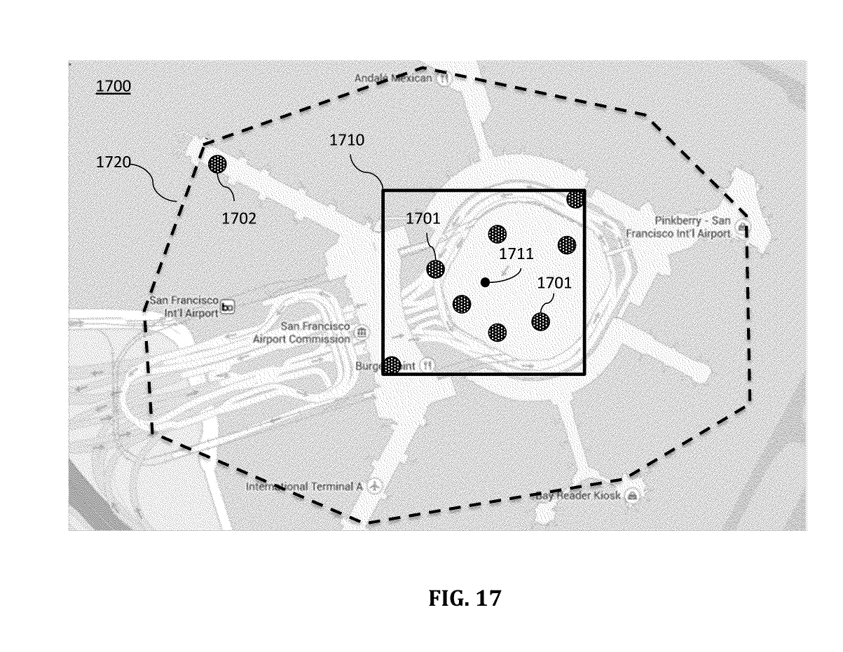

In certain embodiments, as shown in FIG. 17, when an establishment is large, such as an airport 1700, the IP region 1710 derived from the TLLs 1701 with centroid 1711 may not represent the full span of the establishment linked to the same IP address because the TLLs obtained are either concentrated in a small area, or another outlier TLL 1702 is weeded out when deriving the centroid 1711 and the IP region 1710. Thus, the IP region engine would consult the POI database, to see if the calculated IP region is smaller than the POI region stored in the POI database, and if so, the POI region will be stored as the IP region for the IP address in the IP region database.

In certain other embodiments, an IP region could be as large as a zip code when the associated IP address corresponds to a cellular IP address for a cellular tower. Hence, IP ranges could be as small as less than 50 meters, to as large as covering a wide area.

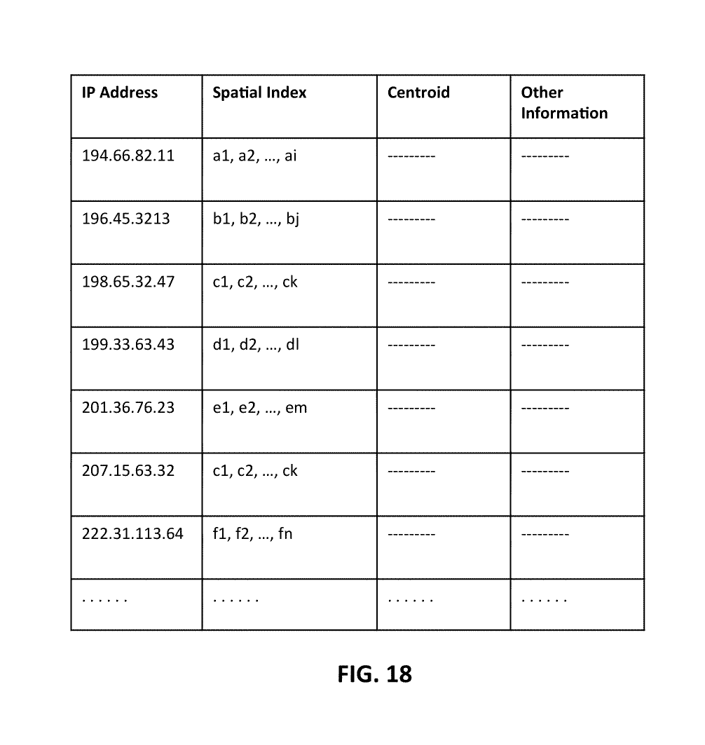

The IP region system 1400 stores the IP regions generated by the IP region creation module 1440 in the database 1450. FIG. 18 illustrates a few examples of IP regions stored in the database 1450 as spatial indices together with the associated IP addresses and other information such as their respective centroids, etc. When an ad request comes in including an IP address but without true LL, the IP regions database 1450 is queried with the IP address, and if a match is found, the centroid of the IP region can be used as an estimated location for the ad request, or the entire IP region can be used as a probable region of the mobile device associated with the ad request.

In certain embodiments, some or all of the systems 300, 700, 1000, and 1400 can be provided by one computer/server 120 or multiple computers/servers 120 coupled to each other via local and/or wide area networks.

We claim:

1. A method performed by one or more first computer systems coupled to a packet-based network to visualize real-time location-based events associated with mobile devices in communication with the packet-based network, the method comprising:
receiving a first request for document from the packet-based network, the first request including a first plurality of parameters associated with a first mobile device;
determining whether the first plurality of parameters indicate a first real-time location-based event of the mobile device being in proximity of a geographic location of a first business;
in response to the first real-time location-based event being determined, updating aggregated historical/statistical data associated with one or more businesses over one or more periods of time; and
transmitting information associated with the first real-time location-based event to one or more second computer systems in the packet-based network, the information enabling the one or more second computer systems to visualize the first real-time location-based event together with other real-time location-based events on one or more display devices.

2. The method of claim 1, wherein updating aggregated data further includes increasing one or more counts of location-based events associated with at least one or the first business, a brand of the first business, and at least one category of the first business over one or more specified period of time, if the first real-time location-based events indicates the mobile device entering the geographical area of the first business.

3. The method of claim 1, wherein the updating aggregated data further includes decreasing a number of mobile devices staying at a second business if the first location-based event indicates the mobile device exiting the second business.

4. The method of claim 1, further comprising transmitting the aggregated data to the one or more second computer systems in response to a request from the one or more second computer systems.

5. The method of claim 4, further comprising transmitting affinity data including one or more counts of location-based events associated with one or more other businesses over one or more specified periods of time, the one or more other businesses having one or more characteristics similar to corresponding characteristics of the first business.

6. The method of claim 1, wherein the first plurality of parameters include at least one location indicator, and wherein determining whether the first request represents a real-time location-based event comprises determining whether the location indicator meets a set of predefined criteria.

7. The method of claim 6, wherein determining whether the first request represents a real-time location-based event further comprises determining whether the location indicator correspond to a geographical location within at least one of a plurality of geo-fences associated with respective ones of the plurality of businesses.

8. The method of claim 7, wherein at least some of the plurality of geo-fences are dynamic geo-fences that vary in shapes and sizes depending on at least one of a plurality of time-dependent factors.

9. The method of claim 1, wherein the first plurality of parameters include at least one characteristic of a user of the first mobile device, and wherein determining whether the first request indicates a real-time location-based event comprises determining whether the at least one characteristic meets one or more predefined criteria.

10. The method of claim 9, wherein the at least one characteristic of the user includes one or both of an age of the user and a gender of the user.

11. The method of claim 10, wherein the one or more predefined criteria comprises an age threshold.

12. The method of claim 1, wherein determining whether the first request indicates a real-time location-based event comprises determining whether the first mobile device has entered or is approaching at least one of a plurality of geo-fences.

13. The method of claim 1, further identifying the first business as a business to which the first mobile device is closest.

14. The method of claim 1, further comprising:
receiving a second request for document from the packet-based network, the second request including a second plurality of parameters associated with the first mobile device;
determining whether the second request indicate a second real-time location-based event of the mobile device being in proximity of a second business; and
estimating a number of mobile devices remaining in the first business using at least the second real-time location-based event

15. A system in communication with a packet-based network including one or more client computers/servers, the system receiving advertisement requests from the packet-based network, the advertisement requests being associated with mobile devices communicating with the publisher computers/servers via the packet-based network, the system comprising:
a location module that examines data associated with each received advertisement (ad) request, and estimates a location of an associated mobile device based on information in the ad request;
a fencing module that determines if the estimated location triggers one or more geo-fences stored in a storage device, the geo-fences representing geographical regions associated with businesses for advertisement campaigns;
a filter/aggregation module that filters the triggered geo-fences to detect real-time location-based events, and to aggregate historical/statistical data related to detected real-time location-based events; and
an application server that organizes and push data associated with the real-time location based event to the one or more client computers/servers, that provides the aggregated historical/statistical in response to requests for the aggregated historical/statistical data from the client computers/servers, thus enabling the client computers/servers to display the real-time location based events over a map together with selected aggregated historical/statistical data.
